(19) United States
(12) Patent Application Publication
(10) Pub. No.: US 2011/0308386 A1
(43) Pub. Date: Dec. 22, 2011

(54) EFFICIENCY-ENHANCED GAS FILTER MEDIUM

(76) Inventors: Jerome Claracq, Oostakker (BE); James F. Sturnfield, Rosharon, TX (US); Peter Cate, Blockley (GB); Wu Chen, Lake Jackson, TX (US); Leonardo C. Lopez, Midland, MI (US)

(21) Appl. No.: 13/106,913

(22) Filed: May 13, 2011

Related U.S. Application Data
(60) Provisional application No. 61/355,315, filed on Jun. 16, 2010.

(51) Int. Cl. B03C 3/28; B23P 11/00; B03C 3/00

(52) U.S. Cl. 95/57; 96/17; 29/428

(57) ABSTRACT

The present invention generally relates to an efficiency-enhanced gas filter medium comprising at least two fiber layers comprising a combination of two or more electrostatically-interacting fiber layers such that the efficiency-enhanced gas filter medium is characterizable by a gas filtration efficiency enhancement from the combination of the two or more electrostatically-interacting fiber layers, and related manufactured articles, processes and methods.

### CROSS-REFERENCE TO RELATED APPLICATIONS

This application claims benefit of U.S. Provisional Patent Application No. 61/355,315, filed Jun. 16, 2010, the entire contents of which are hereby incorporated herein by reference.

### BACKGROUND OF THE INVENTION

1. Field of the Invention

The invention generally relates to an efficiency-enhanced gas filter medium comprising at least two fiber layers comprising a combination of two or more electrostatically-interacting fiber layers such that the efficiency-enhanced gas filter medium is characterizable by a gas filtration efficiency enhancement from the combination of the two or more electrostatically-interacting fiber layers, and related manufactured articles, processes and methods.

2. Background Art

Filtration efficiency when filtering particulates by fiber-containing filter media depends on sizes of the particles (particle size). This is because particle size influences mechanism(s) by which the fiber-containing filter media collects particles (filtration mechanisms), and the filtration mechanism(s) influences amounts of particles collected. In general, an increase in particle size will cause increased particle collection by interception and inertial impaction filtration mechanisms, whereas a decrease in particle size will cause increased particle collection by a Brownian diffusion mechanism. There is an intermediate particle size region where two or more filtration mechanisms can operate simultaneously without dominating the other(s). This intermediate particle size region is where particle penetration through the fiber-containing filter medium is at a maximum and efficiency of the fiber-containing filter medium is at a minimum. The particle size at which the minimum filtration efficiency occurs is referred to as a most penetrating particle.

Filtration efficiency of a gas filter medium filtering particles from a gas containing the particles can be related to penetration of the particles through the gas filter medium (particle penetration) by equations (i) and (ii):

Filtration efficiency=1−Particle Penetration (E=1−P); and (i)

Percent (%) filtration efficiency=100%−Percent Particle Penetration (E(%)=100−P(%)) (ii).

In these equations, particle penetration and filtration efficiency are based on a specific particle size such as size of the most penetrating particle. As can be seen from these equations, decreasing particle penetration leads to increasing filtration efficiency of the gas filter medium and decreasing percent particle penetration leads to increasing percent filtration efficiency of the gas filter medium.

Filtration media, among other things, are mentioned in U.S. Pat. No. 5,672,399 A; U.S. Pat. No. 6,165,572 A; U.S. Pat. No. 6,171,684 B1; U.S. Pat. No. 6,521,321; and U.S. Pat. No. 6,872,431 B2, all family members; U.S. Pat. No. 6,524,360 B2; U.S. Pat. No. 6,872,311; U.S. Pat. No. 7,008,465 B2,X6; U.S. Pat. No. 7,115,150 B2; U.S. Pat. No. 7,316,723 B2; U.S. Pat. No. 7,318,852 B2; U.S. patent application publication number US 2008/0134652 A1 US 2008/0264259 A1; US 2008/0276805 A1; US 2008/0314010 A1; US 2009/0064648 A1; and US 2009/0249956 A1; and PCT International Patent Application Publication Number WO 2008/107006 A1.

U.S. Pat. No. 7,449,053 B2 mentions, among other things, an air filtration cartridge suitable for use in the treatment of air in a forced airflow air supply system. One embodiment includes an ozone generating low power corona discharge ozone generator unit combined with an electrostatic post-filter that may provide a particular synergistic benefit with filter materials mentioned therein.

U.S. Patent Application Publication Number US 2008/0105618 A1 mentions, among other things, a portable water filter including a plurality of different filter medias. One embodiment includes two filters exhibiting a synergistic effect on filtration of water.

There is a need in the art for an improved gas filter media, especially for those which provide higher efficiency at a given pressure drop.

### BRIEF SUMMARY OF THE INVENTION

The present invention provides an efficiency-enhanced gas filter medium, a manufactured article comprising same, and methods and processing of making or using same. The invention efficiency-enhanced gas filter medium comprises at least two fiber layers comprising a combination of two or more electrostatically-interacting fiber layers such that the efficiency-enhanced gas filter medium is characterizable by a gas filtration efficiency enhancement from the combination of the two or more electrostatically-interacting fiber layers. Each of the two or more electrostatically-interacting fiber layers independently comprise fibers as described herein.

In a first embodiment, the present invention provides an efficiency-enhanced gas filter medium comprising at least two fiber layers comprising a combination of two or more electrostatically-interacting fiber layers such that the efficiency-enhanced gas filter medium is characterizable by a gas filtration efficiency enhancement from the combination of the two or more electrostatically-interacting fiber layers. The gas filtration efficiency enhancement is characterized as follows: taken alone (i.e., lacking any electrostatic interaction with each other) each of the two or more electrostatically-interacting fiber layers, independently would be characterizable by a precombination particle penetration; the combination of the two or more electrostatically-interacting fiber layers is characterizable by a measured postcombination particle penetration and a calculated (theoretically expected total) postcombination particle penetration, wherein the calculated postcombination particle penetration is equal to a multiplication product of the precombination particle penetrations; and the gas filtration efficiency enhancement of the efficiency-enhanced gas filter medium is characterizable by a reduction in postcombination particle penetration such that the measured postcombination particle penetration of the combination is less than 0.95 times the calculated postcombination particle penetration (that is, the gas filtration efficiency enhancement formally reduces the measured postcombination particle penetration below 0.95 times the calculated (theoretically expected total) postcombination particle penetration); and wherein all particle penetrations are measured based on a same size test particle (e.g., most penetrating particle size test particle for the efficiency-enhanced gas filter medium, i.e., the combination of layers) having a size from 0.05 micron to 0.20 micron under same measurement conditions. The foregoing provides a means of characterizing the gas filtration efficiency enhancement of the invention efficiency-enhanced gas filter medium. The invention contemplates that the efficiency-enhanced gas filter medium will also exhibit a gas filtration efficiency enhancement with test particles having sizes from greater than 0.20 micron to 0.50 micron.

In a second embodiment, the present invention provides a method of constructing the efficiency-enhanced gas filter medium of the first embodiment, the method comprising combining the two or more electrostatically-interacting fiber layers together in such a way so as to produce a efficiency-enhanced gas filter medium comprising at least two fiber layers comprising a combination of two or more electrostatically-interacting fiber layers such that the efficiency-enhanced gas filter medium is characterizable by a gas filtration efficiency enhancement from the combination of the two or more electrostatically-interacting fiber layers.

In another embodiment the present invention provides a method of filtering a gas, the method comprising directing a gas having particulates and in need of filtration through the efficiency-enhanced gas filter medium as in the first embodiment in such a way that the gas is filtered, thereby providing a filtered gas having a reduced amount of particulates.

In still another embodiment the present invention provides a manufactured article comprising the efficiency-enhanced gas filter medium as in the first embodiment.

The invention efficiency-enhanced gas filter medium is useful in any current or future applications where gas filter media can be employed. Examples of such current applications are air filter media for vehicle compartments and buildings. The invention efficiency-enhanced gas filter medium is also useful in any current or future application enabled by the gas filtration efficiency enhancement thereof.

Without being bound by theory, the invention contemplates that the gas filtration efficiency enhancement results from a synergistic effect (i.e., the gas filtration efficiency enhancement) produced by an electrostatic interaction that occurs between the two or more electrostatically-interacting fiber layers. That is, while the invention contemplates modifications to the efficiency-enhanced gas filter medium such as the modifications described later, the invention efficiency-enhanced gas filter medium produces the gas filtration efficiency enhancement even when the invention efficiency-enhanced gas filter medium consists of the fibers of two or three electrostatically-interacting fiber layers.

As used herein the term “combination” in reference to fiber layers means a multi-layered structure comprising a thickness approximately equal to a sum of the thicknesses of each of the layers (approximately because combining layers could result in some compression or expansion of a fiber layer such that total thickness of the combination might not be exactly equal to the sum of the thicknesses of each of the layers).

The term “constructing” means assembling components and includes preparing or synthesizing materials comprising the components.

The term “efficiency-enhanced gas filter medium” means a composite material suitable for filtering particulates (liquid droplets or, preferably, finely divided solids) from a gas containing particulates (e.g., an aerosol). Examples of solid particulates are dirt, dusts, chopped strand fibers, microorganisms, pollens, powders, and spores. Examples of liquid droplets are oil mists and fogs.

The terms “efficiency-enhanced” and “gas filtration efficiency enhancement” are described later.

The term “electrostatically-interacting” means exhibiting the gas filtration efficiency enhancement and losing the gas filtration efficiency enhancement upon being charged neutralized (e.g., by being contacted with a charge-neutralizing effective amount of 2-propanol).

The term “fiber layer” means a non-woven web of one or more fibers, the non-woven web having a thickness and an area (e.g., rectangular, circular, oval, or irregular) comprising the one or more fibers (the one or more fibers can lay on each other multiple times so as to form the non-woven web).

The term “gas” means a flowable non-liquid, non-plasma substance, including vaporous substances.

The term “manufactured article” means thing or object that has been constructed or prepared. Examples of manufactured articles are finished or unfinished (in construction or preparation) apparatuses, buildings, clothing, devices, instruments, and vehicles.

The term “measurement condition” means a set of experimental parameters employed to determine a dimension, quantity, activity, or capacity. Examples of such experimental parameters for particle penetration measurement in gas filtration are particle size(s) (typically for a mixture of particles having a range of particle sizes), particle composition, gas composition, gas volume flow, sample media tested face area, humidity, temperature, and pressure.

The term “most penetrating particle” means a size of a particle at which minimum filtration efficiency occurs.

The term “particle penetration” means concentration of particles (e.g., in grams per cubic meter) in a downstream air flow divided by concentration of particles (e.g., in grams per cubic meter) in a corresponding upstream air flow.

The terms “postcombination particle penetration” and “precombination particle penetration” are described later.

The phrase “reduction in postcombination particle penetration” means a measured postcombination particle penetration being less than a calculated or theoretical postcombination particle penetration.

The term “test particle” means a finely-divided solid employed in a particle penetration measurement test.

Additional embodiments are described in accompanying drawing(s) and the remainder of the specification, including the claims.

### BRIEF DESCRIPTION OF THE DRAWING(S)

Some embodiments of the present invention are described herein in relation to the accompanying drawing(s), which will at least assist in illustrating various features of the embodiments.

FIG. 1 shows an idealized illustration of a preferred embodiment of the invention efficiency-enhanced gas filter medium.

FIGS. 2a to 2c show the gas filtration efficiency enhancements of the efficiency-enhanced gas filter media of Examples 1a to 1c, respectively, over a range of 0.02 micron to 0.50 micron particle sizes.

FIGS. 3a and 3b show the gas filtration efficiency enhancements of the efficiency-enhanced gas filter media of Examples 2a and 2b, respectively, over a range of 0.02 micron to 0.50 micron particle sizes.

### DETAILED DESCRIPTION OF THE INVENTION

The invention relates to an efficiency-enhanced gas filter medium comprising at least two fiber layers comprising a combination of two or more electrostatically-interacting fiber layers such that the efficiency-enhanced gas filter medium is characterizable by a gas filtration efficiency enhancement from the combination of the two or more electrostatically-interacting fiber layers, and related manufactured articles, processes and methods, all as summarized previously and incorporated here by reference.

For purposes of United States patent practice and other patent practices allowing incorporation of subject matter by reference, the entire contents—unless otherwise indicated—of each U.S. patent, U.S. patent application, U.S. patent application publication, PCT international patent application and WO publication equivalent thereof, referenced in the instant Summary or Detailed Description of the Invention are hereby incorporated by reference. In an event where there is a conflict between what is written in the present specification and what is written in a patent, patent application, or patent application publication, or a portion thereof that is incorporated by reference, what is written in the present specification controls.

In the present application, any lower limit of a range of numbers, or any preferred lower limit of the range, may be combined with any upper limit of the range, or any preferred upper limit of the range, to define a preferred aspect or embodiment of the range. Unless otherwise indicated, each range of numbers includes all numbers, both rational and irrational numbers, subsumed within that range (e.g., the range from about 1 to about 5 includes, for example, 1, 1.5, 2, 2.75, 3, 3.80, 4, and 5).

Certain unsubstituted chemical groups are described herein as having a maximum number of 40 carbon atoms (e.g., (C₁-C₄₀)hydrocarbyl and (C₁-C₄₀)heterohydrocarbyl) for substituent groups (e.g., R groups) where number of carbon atoms is not critical. Forty carbon atoms in such unsubstituted chemical groups is a practical upper limit; nevertheless in some embodiments the invention contemplates such unsubstituted groups having a maximum number of carbon atoms that is higher than 40 (e.g., 100, 1000, or more).

The word “optionally” means “with or without.” For example, “optionally, an additive” means with or without an additive.

In an event where there is a conflict between a compound name and its structure, the structure controls.

In an event where there is a conflict between a unit value that is recited without parentheses, e.g., 2 inches, and a corresponding unit value that is parenthetically recited, e.g., (5 centimeters), the unit value recited without parentheses controls.

As used herein, “a,” “an,” “the,” “at least one,” and “one or more” are used interchangeably. In any aspect or embodiment of the instant invention described herein, the term “about” in a phrase referring to a numerical value may be deleted from the phrase to give another aspect or embodiment of the instant invention. In the former aspects or embodiments employing the term “about,” meaning of “about” can be construed from context of its use. Preferably “about” means from 90 percent to 100 percent of the numerical value, from 100 percent to 110 percent of the numerical value, or from 90 percent to 110 percent of the numerical value. In any aspect or embodiment of the instant invention described herein, the open-ended terms “comprising,” “comprises,” and the like (which are synonymous with “including,” “having,” and “characterized by”) may be replaced by the respective partially closed phrases “consisting essentially of,” consists essentially of,” and the like or the respective closed phrases “consisting of,” “consists of,” and the like to give another aspect or embodiment of the instant invention. The partially closed phrases such as “consisting essentially of” and the like limits scope of a claim to materials or steps recited therein and those that do not materially affect the basic and novel characteristic(s) of the claimed invention. The term “characterizable” is open-ended and means distinguishable.

In the present application, when referring to a preceding list of elements (e.g., ingredients), the phrases “mixture thereof,” “combination thereof,” and the like mean any two or more, including all, of the listed elements. The term “or” used in a listing of members, unless stated otherwise, refers to the listed members individually as well as in any combination, and supports additional embodiments reciting any one of the individual members (e.g., in an embodiment reciting the phrase “10 percent or more,” the “or” supports another embodiment reciting “10 percent” and still another embodiment reciting “more than 10 percent.”). The term “plurality” means two or more, wherein each plurality is independently selected unless indicated otherwise. The terms “first,” “second,” et cetera serve as a convenient means of distinguishing between two or more elements or limitations (e.g., a first chair and a second chair) and do not imply quantity or order unless specifically so indicated. The symbols “≦” and “≧” respectively mean less than or equal to and greater than or equal to. The symbols “<” and “>” respectively mean less than and greater than.

This specification refers to certain well-known air filtration testing standards promulgated by certain organizations, which are referred to herein by their acronyms. The acronym “ANSI” stands for American National Standards Institute, the name of an organization headquartered in Washington, D.C., USA. The acronym “ASHRAE” stands for American Society of Heating, Refrigerating, and Air-Conditioning Engineers, the name of an organization headquartered in Atlanta, Ga., USA. The acronym “ASTM” stands for ASTM International, the name of an organization headquartered in West Conshohocken, Pa., USA; ASTM International was previously known as the American Society for Testing and Materials. The acronym “DIN” stands for Deutsches Institut für Normung e. V., the name of an organization headquartered in Berlin, Germany. The acronym “ISO” stands for International Organization for Standardization, the name of an organization headquartered in Geneva 20, Switzerland. The acronym “MERV” means Minimum Efficiency Reporting Value, an air filtration rating determined using ANSI/ASHRAE Standard 52-2-2007, Method of Testing General Ventilation Air-Cleaning Devices for Removal Efficiency by Particle Size. MERV rating numbers based on ANSI/ASHRAE Standard 52-2-2007 range from 1 to 16. The higher the MERV rating number, the better is removal efficiency for a particular particle size.

### Gas Filtration Efficiency of the Efficiency-Enhanced Gas Filter Medium and Determining Degree of Enhancement Thereof

Filtration efficiency of a gas filter medium filtering particles from a gas containing the particles can be related to penetration of the particles through the gas filter medium (particle penetration) by equations (i) and (ii):

Filtration efficiency=1−Particle Penetration (E=1−P); and (i)

Percent (%) filtration efficiency=100%−Percent Particle Penetration (E(%)=100−P(%)) (ii).

The particle penetration and filtration efficiency are based on a specified particle size such as, for example, the size of the most penetrating particle or size of the particle with which greatest gas filtration efficiency enhancement is determined. As can be seen from these equations, decreasing particle penetration leads to increasing filtration efficiency of the gas filter medium and decreasing percent particle penetration leads to increasing percent filtration efficiency of the gas filter medium.

The particle penetration and the filtration efficiency are a function of particle size. The particle size that gives a largest penetration value is called the most penetrating particle and the largest penetration value is called the most penetrating particle penetration.

Penetration values can be readily determined by a person of ordinary skill in the art. In one example of a penetration value determination test, challenge a filter medium with a gas (e.g., air) dispersion of monodisperse test particles of known composition (e.g., NaCl), charge-neutralization status (charge neutralized or not), and size (e.g., median diameter). Use two condensation particle counters to simultaneously count the upstream and downstream monodisperse test particles. Calculate the penetration value for the monodisperse test particles as a concentration of downstream particles divided by concentration of upstream particles. Subsequently challenge the filter medium (same or, preferably, different samples thereof) with up to 20 (or more) other monodisperse test particles of same composition and charge-neutralization status but different sizes. The other sizes are in a range of from 3 nanometers (m, 0.003 micron)) to 500 nm (0.500 micron), or any one of the other particle size ranges described herein. Calculate penetration values for each of the other known but different-sized monodisperse test particles. At the end of the penetration value determination test generate a graph (curve) of the penetration values versus the respective particle sizes and produce a summary of the penetration value determination test results, including the most penetrating particle size and size with which greatest gas filtration efficiency enhancement, if any, is determined. The penetration value determination test can be conducted manually or using an automated instrument. An example of the automated instrument is CERTITEST Automated Filter tester Model 3160 (TSI, Incorporated, Shoreview, Minn., USA), which if desired can automatically perform the penetration value test with monodisperse test particles having sizes ranging from 0.015 micron to 0.800 micron. All the comparative tests are conducted under the same measurement conditions.

For a gas filter medium comprising a combination of n layers wherein n is an integer of 2 or more, each layer taken alone (i.e., separately) would be characterizable by a gas filtration efficiency and particle penetration and the combination of two or more layers would be characterizable by a gas filtration efficiency and particle penetration. The combination of n layers can be tested to measure a particle penetration (P_{combination}) based on a specific particle size, composition (e.g., NaCl, KCl, or Arizona A2), and charge neutralization status (e.g., charge-neutralized or not charge-neutralized) in the combination of n layers. The n layers can also be tested separately and particle penetrations determined therefor (P_{layer 1}, P_{layer 2}, . . . and P_{layer n}) based on the same specified particle size (for the combination). An expected or theoretical particle penetration for the combination of n layers can be calculated (P calculated) as a multiplication product of the particle penetrations of the separate layers as shown in equation (iii):

P_{calculated}=P_{layer 1}·P_{layer 2} . . . ·P_{layer n} (iii)

Since equation (i) (and equation (ii)) indicates decreasing particle penetration increases filtration efficiency, if P_{combination} is less than P_{calculated}, the gas filter medium can be characterized as having a synergistic filtration efficiency, i.e., the gas filtration efficiency enhancement. The relationship between P_{combination} and P_{calculated} is shown in equation (iv):

P_{combination}=r·P_{calculated} (iv)

wherein r is a particle penetration reduction factor related to a degree of the gas filtration efficiency enhancement for that particle size. The lower is a value of r, the greater is the gas filtration efficiency enhancement. For the invention efficiency-enhanced gas filter medium, the gas filtration efficiency enhancement is present when r is less than (<) 1.00. The invention contemplates all r<1.00. For practical reasons, preferably r is <0.95. More preferably r<0.90, still more preferably r<0.85, still more preferably r<0.75, even more preferably r<0.70, and yet more preferably r<0.65. In some embodiments the same size test particle is a most penetrating particle size for the combination of n layers. In other embodiments the same size test particle is other than the most penetrating particle size. In some embodiments the same size test particle is the test particle size producing the greatest gas filtration efficiency enhancement, i.e., producing the smallest reduction factor, r. In some embodiments the test particle size producing the smallest reduction factor, r, and the most penetrating particle size are the same. In other embodiments the test particle size producing the smallest reduction factor, r, and the most penetrating particle size are different. Preferably the test particle size producing the smallest reduction factor, r, is from 0.05 micron to 0.20 micron.

Additional details on determining the gas filtration efficiency enhancement are provided later in the Methods section.

### Efficiency-Enhanced Gas Filter Medium

In a preferred embodiment one or more of the two or more electrostatically-interacting fiber layers comprises submicron fibers comprising an electroresponsive material comprising an electroresponsive organic polymer.

In a more preferred embodiment, one of the two or more electrostatically-interacting fiber layers comprises an electrostatically-charged fiber layer comprising electrostatically-charged fibers and having spaced-apart upstream and downstream faces and an effective amount of an electrostatic charge, wherein the electrostatically-charged fibers have a median fiber diameter of from greater than 500 nanometers to 1000 microns; and another one of the two or more electrostatically-interacting fiber layers comprises an electroresponsive submicron fiber layer having spaced-apart upstream and downstream faces and comprising electroresponsive submicron fibers comprising an electroresponsive material, wherein the electroresponsive submicron fibers have a median fiber diameter of 500 nanometers (nm) or less and the electroresponsive material is characterizable as having a relative static permittivity (εᵣ) of 2.6 or greater at room temperature under 1 kilohertz applied potential; and wherein the electroresponsive submicron fiber layer is disposed within an electroresponsive distance from the electrostatically-charged fiber layer in such a way so as to produce the gas filtration efficiency enhancement. In some embodiments the downstream face of the electroresponsive submicron fiber layer is disposed within the electroresponsive distance from the upstream face of the electrostatically-charged fiber layer such that an air flow would sequentially penetrate the electroresponsive submicron fiber layer and then the electrostatically-charged fiber layer. Preferably, however, the upstream face of the electroresponsive submicron fiber layer is disposed within the electroresponsive distance from the downstream face of the electrostatically-charged fiber layer such that an air flow would sequentially penetrate the electrostatically-charged fiber layer and then the electroresponsive submicron fiber layer. As used herein, the term “room temperature” means a degree of hotness or coldness of from 20° C. to 25° C. Preferably, the electroresponsive submicron fiber layer is electrostatically neutral, although alternatively it can differ in degree or polarity (negative versus positive) of electrical charge from the local electrical potential of adjacent fiber layers.

Without being bound by theory, the invention contemplates an advantage whereby the electrostatically-charged fiber layer has a local electrical potential on its face (upstream or downstream, as the case may be) nearest and within the electroresponsive distance from the electroresponsive submicron fiber layer that is different than any local electrical potential at a nearest face of the electroresponsive submicron fiber layer, and this local electrical potential of the electrostatically-charged fiber layer generates an electrical field that interacts with the electroresponsive material of the electroresponsive submicron fiber layer in such a way so as to generate the gas filtration efficiency enhancement. The electrostatically-charged fiber layer has been electrostatically charged or the invention efficiency-enhanced gas filter medium has been assembled in such a way so as to create the local electrical potential at the face of electrostatically-charged fiber layer that is different than the any local electrical potential at a nearest face of the electroresponsive submicron fiber layer.

Without being bound by theory, the invention contemplates another advantage whereby the invention gas filtration efficiency enhancement is greater with the electroresponsive submicron fiber layer comprising the submicron fibers of the electroresponsive material than it would be, if any enhancement would be observed at all, with an electroresponsive fiber layer having micron size or larger fibers of the electroresponsive material. It is believed that this is so because the submicron size(s) of the electroresponsive submicron fiber(s) exposes a relatively larger surface area of the electroresponsive material to an electric field compared to what surface area of the electroresponsive material would be exposed thereto if the size(s) of the electroresponsive fibers were micron size or larger.

Without being bound by theory, the invention contemplates still another advantage whereby the invention gas filtration efficiency enhancement is greater with increasing relative static permittivity (εᵣ) of the electroresponsive material of the electroresponsive submicron fiber layer.

Without being bound by theory, the invention contemplates still another advantage whereby the electrostatically-charged fiber layer (upstream) can increase random motion of any smaller particles (e.g., 0.5 micron or less) that penetrate it (i.e., pass through it), and thus increase likelihood that these smaller particles are captured by the electroresponsive submicron fiber layer.

Without being bound by theory, the invention contemplates still another advantage whereby when the efficiency-enhanced gas filter medium further comprises a downstream fiber layer (e.g., a support or protective layer) having an upstream face within an electroresponsive distance from the downstream face of the electroresponsive submicron fiber layer, and the upstream face of the downstream fiber layer has another local electrical potential that is different from the local electrical potential at the downstream face of the electroresponsive submicron fiber layer. In such embodiments, it is believed that another electric field interacts with the electroresponsive material of the electroresponsive submicron fiber layer in such a way so as to generate a gradient of electrical potential across the electroresponsive submicron fiber layer and generate an even greater degree of the gas filtration efficiency enhancement than that generated when the invention efficiency-enhanced gas filter medium lacks such a downstream fiber layer.

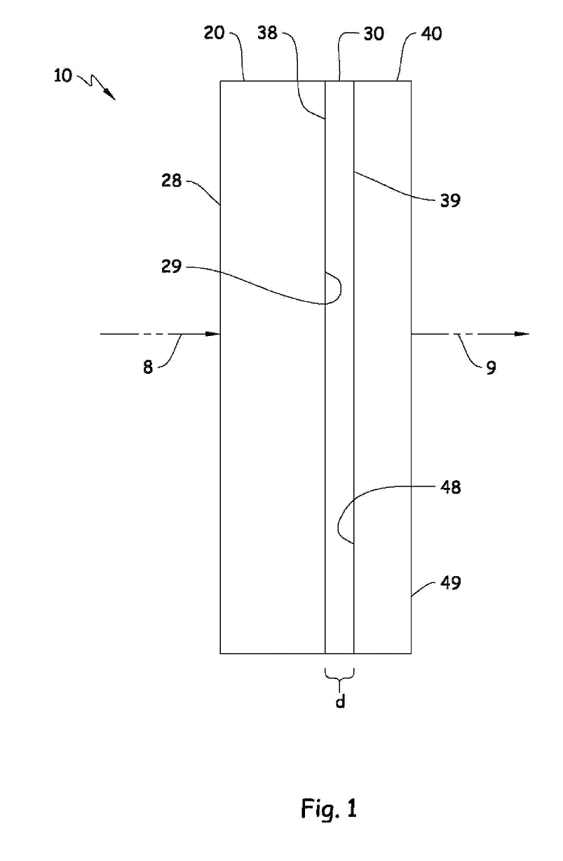

As mentioned previously, FIG. 1 shows the idealized illustration of a preferred embodiment of the invention efficiency-enhanced gas filter medium. In FIG. 1, the preferred embodiment comprises efficiency-enhanced gas filter medium 10. Efficiency-enhanced gas filter medium 10 comprises, sequentially in an upstream to downstream direction, electrostatically-charged fiber layer 20, electroresponsive submicron fiber layer 30, and downstream fiber layer 40.

Referring again to FIG. 1, electrostatically-charged fiber layer 20 has upstream face 28 and downstream face 29 and comprises electrostatically charged fibers (not indicated) having the median diameter as described elsewhere herein.

Referring again to FIG. 1, electroresponsive submicron fiber layer 30 has upstream face 38 and downstream face 39 and comprises electroresponsive submicron fiber(s) (not indicated) having a median fiber diameter (not shown) and the electroresponsive submicron fiber(s) comprises a layer having thickness, d, between upstream face 38 and downstream face 39, all as described elsewhere herein. Preferably d is 2.0 millimeters (mm) or less) such that downstream face 39 of electroresponsive submicron fiber layer 30 is within 2.0 mm of downstream face of electrostatically-charged fiber layer 20. The electroresponsive submicron fibers are comprised of an electroresponsive material (not indicated) as described elsewhere herein.

Referring again to FIG. 1, downstream fiber layer 40 has upstream face 48 and downstream face 49. In some embodiments the downstream fiber layer 40 functions as a protective layer, support layer, a third one of the two or more electrostatically-interacting fiber layers, or a combination thereof. The protective layer functions by inhibiting loss of or preventing mechanical damage to, or both the electroresponsive submicron fibers (not indicated) of electroresponsive submicron fiber layer 30 (e.g., during manufacturing of the electroresponsive submicron fibers (not indicated), during manufacturing or handling of efficiency-enhanced gas filter medium 10, or a combination thereof). The support layer functions by collecting the electroresponsive submicron fibers (not indicated) of electroresponsive submicron fiber layer 30 during manufacturing of the electroresponsive submicron fibers (not indicated). The third one of the two or more electrostatically-interacting fiber layers comprises a material that is not electrostatically charged or is electrostatically charged and has been constructed so that locally there is a difference between electrostatic charge of downstream fiber layer 40 and electrostatic charge of electrostatically-charged fiber layer 20 (for example wherein electrostatic charge of downstream fiber layer 40 is a positive charge and electrostatic charge of electrostatically-charged fiber layer 20 is negative charge, or vice versa such that electrical polarity of the charges are opposite).

Referring again to FIG. 1, assemble efficiency-enhanced gas filter medium 10 by laminating electrostatically-charged fiber layer 20, electroresponsive submicron fiber layer 30, and downstream fiber layer 40 to each other. In a preferred embodiment, prepare and assemble efficiency-enhanced gas filter medium 10 by electrospinning or melt blowing a melt of the electroresponsive material to produce respective melt electrospun or melt blown forms of the electroresponsive submicron fibers, and directly collecting the electroresponsive submicron fibers on upstream face 48 of downstream fiber layer 40, thereby preparing an intermediate laminate comprising downstream face 39 of electroresponsive submicron fiber layer 30 in laminating operative contact to upstream face 48 of downstream fiber layer 40. Thus in such fiber making steps, downstream fiber layer 40 serves as collectors useful in collecting melt electrospun or melt blown electroresponsive submicron fibers, respectively. Then, contact downstream face 29 of electrostatically-charged fiber layer 20 to upstream face 38 of electroresponsive submicron fiber layer 30, or vice versa, in such a way so as to prepare efficiency-enhanced gas filter medium 10. Alternatively, the melt electrospun or melt blown electroresponsive submicron fibers are collected on a temporary collector, and the resulting electroresponsive submicron fiber layer removed therefrom and laminated to downstream face 29 of electrostatically-charged fiber layer 20 and upstream face 48 of downstream fiber layer 40 in such a way so as to prepare efficiency-enhanced gas filter medium 10.

Referring again to FIG. 1, employ efficiency-enhanced gas filter medium 10 in an embodiment of the invention method of filtering a gas in need thereof. In this embodiment, the method comprises directing a gas in need of filtration (e.g., air containing aerosol particulates comprising particulates having diameters of from 0.03 micron to 0.52 micron) through efficiency-enhanced gas filter medium 10. The directing comprises the gas in need of filtration entering efficiency-enhanced gas filter medium 10 at upstream face 28 of electrostatically-charged fiber layer 20 as indicated by arrow 8 and a filtered gas exiting efficiency-enhanced gas filter medium 10 via downstream face 49 of downstream fiber layer 40 as indicated by arrow 9. Preferably the directing comprises disposing efficiency-enhanced gas filter medium 10 in a stream of the gas in need of filtration in such a way that the entering and exiting are performed. Preferably, the method thereby removes at least some of the particulates from the gas in need of filtration in such a way that the filtered gas contains 10% or less thereof. Preferably, the particulates removed by the method include particulates having diameters of form 0.05 micron to 0.20 micron such that the method is readily characterizable as having the gas filtration efficiency enhancement.

The invention contemplates the efficiency-enhanced gas filter medium having any total number of fiber layers. Preferably, the invention efficiency-enhanced gas filter medium has a total number of from 2 to 6 fiber layers, more preferably from 2 to 5 fiber layers, still more preferably 3 or 4 fiber layers, and even more preferably 3 fiber layers. The total number of fiber layers is greater than or equal to a total number of the electrostatically-interacting fiber layers. In some embodiments the total number of fiber layers is as described later in any one of the Examples.

The invention efficiency-enhanced gas filter medium is characterized by the gas filtration efficiency enhancement. As mentioned before, when measuring particle penetrations for determining the gas filtration efficiency enhancement, all particle penetrations are measured under same measurement conditions. Examples of measurement conditions of particular interest are gas composition, percent relative humidity (% RH) and face velocity of the gas, temperature, pressure (ambient), and test particle composition and size. Preferably, the gas being filtered is air. Preferably, the air being filtered has a same percent relative humidity of from 20% RHto 80% RH, preferably 50%±5% RH, and more preferably 50% RH. Preferably the air being filtered has a same face velocity of from 20 feet per minute (fpm) to 140 fpm, and more preferably 30 fpm or 9.1 meters per minute. Preferably, the gas filtration efficiency enhancement is measured at a pressure of 101 kilopascals and a temperature of from 20 degrees Celsius to 26 degrees Celsius. Preferably the gas filtration efficiency enhancement is measured with charge-neutralized sodium chloride particles, and more preferably sodium chloride particles that are not charge-neutralized (i.e., more preferably sodium chloride particles having an electrostatic charge, which preferably is a residual electrostatic charge obtained from the preparation and processing of the sodium chloride particles). The NaCl particles have an average diameter of from 0.050 micron to 0.20 micron according to the NaCl procedure described later. Other ionic particles such as KCl and electrostatically-charged particles could also be used to measure the gas filtration efficiency enhancement. In some embodiments the measurement conditions as described later in any one of the Examples.

More preferably, the gas filtration efficiency enhancement of the efficiency-enhanced gas filter medium is characterizable by the reduction in postcombination particle penetration such that the measured postcombination particle penetration of the combination is less than 0.90 times, still more preferably less than 0.85 times, still more preferably less than 0.75 times, even more preferably less than 0.70 times, and yet more preferably less than 0.65 times the calculated postcombination particle penetration, wherein the same size test particle is a most penetrating particle size. That is preferably the particle penetration reduction factor r is <0.90, more preferably r<0.85, still more preferably r<0.75, even more preferably r<0.70, and yet more preferably r<0.65. In other embodiments, the same size test particle is the test particle size producing the smallest reduction factor, r, wherein the test particle size is from 0.05 micron to 0.20 micron. In some embodiments r is as described later in any one of the Examples.

Preferably, one or more of the two or more electrostatically-interacting fiber layers of the efficiency-enhanced gas filter medium comprises an electroresponsive material comprising an electroresponsive organic polymer. The term “electroresponsive” means capable of electrostatically-interacting with the electrostatically-charged fiber layer in such a way so as to produce the gas filtration efficiency enhancement.

The invention contemplates the efficiency-enhanced gas filter medium having any number of electrostatically-interacting fiber layers. Preferably, the invention efficiency-enhanced gas filter medium has a total of from 2 to 5 electrostatically-interacting fiber layers, more preferably from 2 to 4 electrostatically-interacting fiber layers, and still more preferably 2 or 3 electrostatically-interacting fiber layers. In some embodiments there are 3 electrostatically-interacting fiber layers and in other embodiments 4 electrostatically-interacting fiber layers. In some embodiments the number of electrostatically-interacting fiber layers is as described later in any one of the Examples.

Preferably, the electroresponsive submicron fibers have a median fiber diameter of 400 nanometers or less, more preferably 330 nm or less, still more preferably 299 nm or less, even more preferably 260 nm or less, and yet more preferably 240 nm or less. In some embodiments the median fiber diameter of the submicron fibers is as described later in any one of the Examples.

A convenient way of selecting electroresponsive materials is by choosing those having a relative static permittivity (εᵣ) of 2.6 or greater at room temperature (20° C. to 25° C.) under 1 kilohertz (1000 Hertz) applied potential. The relative static permittivity (εᵣ) is determined according to the ASTM method described later. While it is believed that a vast majority of materials having εᵣ of 2.6 or greater at room temperature under 1 kilohertz applied potential are electroresponsive as that term is used herein, it cannot be said that all do. In all embodiments the gas filtration efficiency enhancement characteristic controls.

Preferably relative static permittivity (εᵣ) of the electroresponsive material is greater than 2.6 at room temperature (20° C. to 25° C.) under 1 kilohertz applied potential. Still more preferably εᵣ at room temperature under 1 kilohertz applied potential is εᵣ 3.4 or greater, even more preferably εᵣ 3.9 or greater. In some embodiments such εᵣ is 4.9 or greater, and in other embodiments εᵣ 5.9 or greater. In some embodiments such εᵣ is 10.0 or greater, and more preferably 12.0 or greater. In some embodiments the εᵣ of the electroresponsive material is less than 13.0 at room temperature (20° C. to 25° C.) under 1 kilohertz applied potential, in other embodiments less than 6.0, in still other embodiments less than 5.0, and in still other embodiments less than 4.0. In some embodiments εᵣ is the same as that of any one of the Examples described later.

The invention contemplates any electroresponsive distance. The term “electroresponsive distance” means a degree of separation that allows the electroresponsive submicron fiber layer and the electrostatically charged fiber layer to interact in such a way so as to produce the gas filtration efficiency enhancement. Preferably, the electroresponsive distance is 2.0 millimeters (mm) or less. More preferably, the electroresponsive distance is measured between the downstream face of the electrostatically-charged fiber layer and the downstream face of the electroresponsive submicron fiber layer. Still more preferably, the downstream face of the electrostatically-charged fiber layer and the upstream face of the electroresponsive submicron fiber layer are disposed in direct physical contact with each other (i.e., the electroresponsive distance is 0 mm). In some embodiments the electroresponsive distance is the same as that of any one of the Examples described later.

Preferably, the electroresponsive material comprises an electroresponsive organic polymer. In some embodiments, the electroresponsive material consists essentially of the electroresponsive organic polymer or a mixture or blend of two or more electroresponsive organic polymers. Preferably the number of electroresponsive organic polymers is 6 or less, more preferably 4 or less, still more preferably 3 or less, and even more preferably 2 or less. In some embodiments the number of electroresponsive organic polymers is 1. In some embodiments the number of electroresponsive organic polymers is as described later in any one of the Examples.

The invention contemplates using any electroresponsive organic polymer(s). In some embodiments the electroresponsive organic polymer is an electroresponsive polyamide (e.g., nylon-6 and polycaprolactam). In other embodiments the electroresponsive organic polymer is an electroresponsive molecularly self-assembling material. Preferably, the electroresponsive molecularly self-assembling material is an electroresponsive polyester-amide, electroresponsive polyether-amide, electroresponsive polyester-urethane, electroresponsive polyether-urethane, electroresponsive polyether-urea, electroresponsive polyester-urea, or a mixture of two or more thereof. In some embodiments the electroresponsive organic polymer(s) is as described later in any one of the Examples.

The term “molecularly self-assembling material” or “molecularly self-assembled material” or “MSA material” means an oligomer or polymer that effectively forms larger associated or assembled oligomers and/or polymers through the physical intermolecular associations of chemical functional groups. Without wishing to be bound by theory, it is believed that the intermolecular associations do not increase the molecular weight (Mn-Number Average molecular weight) or chain length of the MSA material and covalent bonds between said materials do not form. This combining or assembling occurs spontaneously upon a triggering event such as cooling to form the larger associated or assembled oligomer or polymer structures. Examples of other triggering events are the shear-induced crystallizing of, and contacting a nucleating agent to, a MSA material.

Accordingly, MSA materials can exhibit mechanical properties similar to some higher molecular weight synthetic polymers and viscosities like very low molecular weight compounds. Molecularly self-assembling organization (self-assembly) is caused by non-covalent bonding interactions, often directional, between molecular functional groups or moieties located on individual molecular (i.e. oligomer or polymer) repeat units (e.g. hydrogen-bonded arrays). Non-covalent bonding interactions include: electrostatic interactions (ion-ion, ion-dipole or dipole-dipole), coordinative metal-ligand bonding, hydrogen bonding, π-π-structure stacking interactions, donor-acceptor, and/or van der Waals forces and can occur intra- and intermolecularly to impart structural order. Preferably, the electroresponsive molecularly self-assembling material comprises self-assembling units comprising multiple hydrogen bonding arrays.

One preferred mode of self assembly is hydrogen-bonding and this non-covalent bonding interactions can be defined by a mathematical “Association constant”, K(assoc) constant describing the relative energetic interaction strength of a chemical complex or group of complexes having multiple hydrogen bonds. Such complexes give rise to the higher-ordered structures in a mass of MSA materials. A description of self-assembling multiple H-bonding arrays can be found in “Supramolecular Polymers”, Alberto Ciferri Ed., 2nd Edition, pages (pp) 157-158. A “hydrogen bonding array” is a purposely synthesized set (or group) of chemical moieties (e.g. carbonyl, amine, amide, hydroxyl. etc.) covalently bonded on repeating structures or units to prepare a self-assembling molecule so that the individual functional moieties can form self-assembling donor-acceptor pairs with other donors and acceptors on the same, or different, molecule. A “hydrogen bonded complex” is a chemical complex formed between hydrogen bonding arrays. Hydrogen bonded arrays can have association constants K (assoc) between 10² and 10⁹ M⁻¹ (reciprocal molarities), generally greater than 10³ M⁻¹. The arrays can be chemically the same or different and form complexes. The multiple H-bonding arrays preferably comprise an average of 2 to 8, more preferably 4 to 6, and still more preferably at least 4 donor-acceptor hydrogen bonding moieties per self-assembling unit. Self-assembling units in the MSA material can include bis-amide groups, and bis-urethane group repeat units and their higher oligomers.

Accordingly, the molecularly self-assembling materials suitable for use in the present invention include: molecularly self-assembling polyesteramides, copolyesteramide, copolyetheramide, copolyetherester-amide, copolyetherester-urethane, copolyether-urethane, copolyester-urethane, copolyester-urea, copolyetherester-urea and their mixtures. Preferred MSA materials include copolyesteramide, copolyether-amide, copolyester-urethane, and copolyether-urethanes.

The MSA materials can include “non-aromatic hydrocarbylene groups” and this term means specifically herein hydrocarbylene groups (a divalent radical formed by removing two hydrogen atoms from a hydrocarbon) not having or including any aromatic structures such as aromatic rings (e.g. phenyl) in the backbone of the oligomer or polymer repeating units. These groups can optionally be substituted with various substituents, or functional groups, including but not limited to: halides, alkoxy groups, hydroxy groups, thiol groups, ester groups, ketone groups, carboxylic acid groups, amines, and amides. A “non-aromatic heterohydrocarbylene” is a hydrocarbylene that includes at least one non-carbon atom (e.g. N, O, S, P or other heteroatom) in the backbone of the polymer or oligomer chain, and that does not have or include aromatic structures the backbone of the polymer or oligomer chain. These groups can optionally be substituted with various substituents, or functional groups, including but not limited to: halides, alkoxy groups, hydroxy groups, thiol groups, ester groups, ketone groups, carboxylic acid groups, amines, and amides. Heteroalkylene is an alkylene group having at least one non-carbon atom (e.g. N, O, S or other heteroatom) that can optionally be substituted with various substituents, or functional groups, including but not limited to: halides, alkoxy groups, hydroxy groups, thiol groups, ester groups, ketone groups, carboxylic acid groups, amines, and amides. For the purpose of this disclosure, a “cycloalkyl” group is a saturated carbocyclic radical having three to twelve carbon atoms, preferably three to seven. A “cycloalkylene” group is an unsaturated carbocyclic radical having three to twelve carbon atoms, preferably three to seven. The cycloalkylene can be monocyclic, or a polycyclic fused system as long as no aromatic structures are included. Cycloalkyl and cycloalkylene groups can be monocyclic, or a polycyclic fused system as long as no aromatic structures are included. Examples of such carbocyclic radicals include cyclopropyl, cyclobutyl, cyclopentyl, cyclohexyl and cycloheptyl. The groups herein can be optionally substituted in one or more substitutable positions. For example, cycloalkyl and cycloalkylene groups can be optionally substituted with, among others, halides, alkoxy groups, hydroxy groups, thiol groups, ester groups, ketone groups, carboxylic acid groups, amines, and amides. Cycloalkyl and cycloalkene groups can optionally be incorporated into combinations with other groups to form additional substituent groups, for example: “-Alkylene-cycloalkylene-, “-alkylene-cycloalkylene-alkylene-”, “-heteroalkylene-cycloalkylene-”, and “-heteroalkylene-cycloalkyl-heteroalkylene” which refer to various non-limiting combinations of alkyl, heteroalkyl, and cycloalkyl. These can include groups such as oxydialkylenes (e.g., diethylene glycol), groups derived from branched diols such as neopentyl glycol or derived from cyclo-hydrocarbylene diols such as Dow Chemical's UNOXOL® isomer mixture of 1,3- and 1,4-cyclohexanedimethanol, and other non-limiting groups, such -methylcylohexyl-, -methyl-cyclohexyl-methyl-, and the like. The cycloalkyl can be monocyclic, or a polycyclic fused system as long as no aromatic structures are included. “Heterocycloalkyl” is one or more carbocyclic ring systems having 4 to 12 atoms and containing at least one and up to four heteroatoms selected from nitrogen, oxygen, or sulfur. This includes fused ring structures. Preferred heterocyclic groups contain two ring nitrogen atoms, such as piperazinyl. The heterocycloalkyl groups herein can be optionally substituted in one or more substitutable positions. For example, heterocycloalkyl groups may be optionally substituted with halides, alkoxy groups, hydroxy groups, thiol groups, ester groups, ketone groups, carboxylic acid groups, amines, and amides.

A preferred class of MSA materials useful in the presently invention are polyester-amide and polyester-urethane polymers (optionally containing polyether units) such as those described in U.S. Pat. No. 6,172,167, US 2010/0037576 A1, or US 2010/0064647 A1.

In a set of preferred embodiments, the MSA material comprises ester repeat units of Formula I:

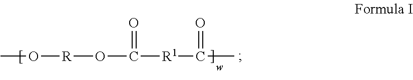

and at least one second repeat unit selected from the esteramide units of Formula II and III:

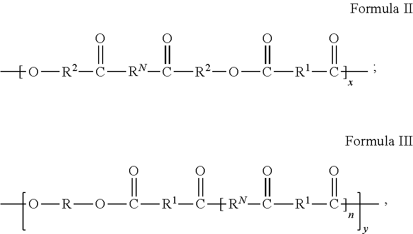

and the ester-urethane units of Formula IV:

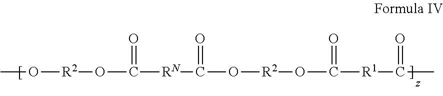

R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 to about 5000 g/mol. In preferred embodiments, the C₂-C₂₀ non-aromatic hydrocarbylene at each occurrence is independently specific groups: alkylene-, -cycloalkylene-, -alkylene-cycloalkylene-, -alkylene-cycloalkylene-alkylene-(including dimethylene cyclohexyl groups). Preferably, these aformentioned specific groups are from 2 to 12 carbon atoms, more preferably from 3 to 7 carbon atoms. The C₂-C₂₀ non-aromatic heterohydrocarbylene groups are at each occurrence, independently specifically groups, non-limiting examples including: -hetereoalkylene-, -heteroalkylene-cycloalkylene-, -cycloalkylene-heteroalkylene-, or -heteroalkylene-cycloalkylene-heteroalkylene-, each aforementioned specific group preferably comprising from 2 to 12 carbon atoms, more preferably from 3 to 7 carbon atoms. Preferred heteroalkylene groups include oxydialkylenes, for example diethylene glycol (—CH₂CH₂OCH₂CH₂—O—). When R is a polyalkylene oxide group it can preferably be a polytetramethylene ether, polypropylene oxide, polyethylene oxide, or their combinations in random or block configuration wherein the molecular weight (Mn-average molecular weight, or conventional molecular weight) is preferably about 250 g/ml to 5000, g/mol, more preferably more than 280 g/mol, and still more preferably more than 500 g/mol, and is preferably less than 3000 g/ml: mixed length alkylene oxides can be also be included. Other preferred embodiments include species where R is the same C₂-C₆ alkylene group at each occurrence, and more preferably it is —(CH₂)₄—.

R¹ is at each occurrence, independently, a bond, or a C₁-C₂₀ non-aromatic hydrocarbylene group. In some preferred embodiments, R¹ is the same C₁-C₆ alkylene group at each occurrence, more preferably —(CH₂)₄—.

R² is at each occurrence, independently, a C₁-C₂₀ non-aromatic hydrocarbylene group. According to another embodiment, R² is the same at each occurrence, preferably C₁-C₆ alkylene, and even more preferably R² is —(CH₂)₂—, —(CH₂)₃—, —(CH₂)₄—, or —(CH₂)₅—.

R^{N} is at each occurrence can be —N(R³)—Ra—N(R³)—, where R³ is independently H or can be a C₁-C₆ alkyl, preferably C₁-C₄ alkyl, or R^{N} is a C₂-C₂₀ heterocycloalkylene group containing the two nitrogen atoms, wherein each nitrogen atom is bonded to a carbonyl group according to Formula II or III above; w represents the ester mol fraction, and x, y and z represent the amide or urethane mole fractions where w+x+y+z=1, 0<w<1, and at least one of x, y and z is greater than zero. Ra is a C₂-C₂₀ non-aromatic hydrocarbylene group, more preferably a C₂-C₁₂ alkylene: more preferred Ra groups are ethylene butylene, and hexylene —(CH₂)₆—. R^{N} can be piperazinyl. According to another embodiment, both R³ groups are hydrogen.

n is at least 1 and has a mean value less than 2.

In an alternative embodiment, the MSA material can be a polymer consisting of repeat units of either Formula II or Formula III, wherein R, R′, R², R^{N}, and n are as defined above and x+y=1, and 0≦x≦1 and 0≦y≦1.

It should be noted that for convenience the chemical repeat units for various embodiments are shown independently. The invention encompasses all possible distributions of the w, x, y, and z units in the copolymers, including randomly distributed w, x, y and z units, alternatingly distributed w, x, y and z units, as well as partially, and block or segmented copolymers, the definition of these kinds of copolymers being used in the conventional manner. In some embodiments, the mole fraction of w to (x+y+z) units can be between about 0.1:0.9 and about 0.9:0.1. In some preferred embodiments, the copolymer can comprise at least 15 mole percent w units, at least 25 mole percent w units, or at least 50 mole percent w units.

In some embodiments the electroresponsive molecularly self-assembling material has a number average molecular weight (Mn) of from 1000 grams per mole to 50,000 grams per mole The electroresponsive MSA material preferably has a number average molecular weight, Mₙ (as is preferably determined by NMR spectroscopy) of 2000 grams per mole (g/mol) or more, more preferably at least about 3000 g/mol, and even more preferably at least about 4000 g/mol. The MSA material preferably has MWₙ 50,000 g/mol or less, more preferably about 20,000 g/mol or less, still more preferably about 15,000 g/mol or less, even more preferably about 12,000 g/mol or less, and yet more preferably 9,000 g/mol or less. In some embodiments the number average molecular weight (Mₙ) of the electroresponsive molecularly self-assembling material is from 2000 grams per mole to 12,000 grams per mole and in other embodiments from 2000 grams per mole to 9,000 grams per mole. In some embodiments the Mₙ is as described later for or in any one of the Examples.

In a preferred embodiment the melt viscosity (zero shear viscosity) of the MSA material is less than 500 Pascal·-seconds. (abbreviated as Pa·s or Pa·sec of Pa-seconds), preferably less than 250 Pa·-seconds., even more preferably less than 100 Pa·-seconds from above Tₘ up to about 40 degrees ° C. above Tₘ (Tₘ being the polymer melting temperature, preferably as determined by DSC). In some embodiments the melt viscosity is as described later for or in any one of the Examples.

In some embodiments the electroresponsive submicron fibers are non-fibrillated. As used herein, the term “non-fibrillated” means substantially lacking signs in scanning electron microscope (SEM) images of projections (e.g., relatively short hair-like filaments) along axes of the electroresponsive submicron fibers. Such projections are a hallmark of mechanical wear that inherently results from fibrillation techniques. Such projections are essentially lacking in the electroresponsive submicron fibers produced by melt electrospinning or melt blowing a molecularly-self assembling (MSA) material as described later. In some embodiments the electroresponsive submicron fibers are non-fibrillated and the electroresponsive submicron fiber layer has a filtration efficiency of less than or equal to 99.0 percent when capturing aerosol 0.18 micron size particles at a flow rate of about 32 liters per minute through a sample of the electroresponsive submicron fiber layer of 100 square centimeters in size. In some embodiments the fibers are the non-fibrillated fibers as described later in any one of the Examples.

In some embodiments the efficiency-enhanced gas filter medium is characterizable by filtration efficiency, pressure drop, particle loading capacity, or a combination thereof. Preferably the efficiency-enhanced gas filter medium has a most penetrating particle-based filtration efficiency of 30% or greater, more preferably 50% or greater, still more preferably 70% or greater, and even more preferably 90% or greater. In some embodiments the most penetrating particle-based filtration efficiency is the same as that of any one of the Examples described later.

The invention contemplates employing any electrostatically-charged fiber layer. The electrostatically-charged fiber layer comprises electrostatically-charged fibers comprising an electrostatically-charged material. Preferably, the electrostatically-charged fibers have a median fiber diameter of from 0.5 micron to 1000 microns, more preferably less than 200 microns, still more preferably less than 50 microns, and even more preferably less than 10 microns. Preferably, the electrostatically-charged material comprises a glass or an organic polymer (e.g., polypropylene or polyester). In some embodiments the median fiber diameter is the same as that of any one of the Examples described later.

Preferably, the efficiency-enhanced gas filter medium further comprises a downstream fiber layer in laminating operative contact to the downstream face of the electroresponsive submicron fiber layer. The invention contemplates employing any downstream fiber layer so long as the efficiency-enhanced gas filter medium retains at least some of the gas filtration efficiency enhancement.

In some embodiments the downstream fiber layer has a charge of opposite electrical polarity to charge of the electrostatically-charged fiber layer (negatively charged versus positively charged or vice versa). The downstream fiber layer is preferably charge neutral. In some embodiments the downstream fiber layer functions as a protective layer, support layer, a third one of the two or more electrostatically-interacting fiber layers, or a combination of two or more thereof. The protective layer functions by inhibiting loss of, preventing mechanical damage to, or both the electroresponsive submicron fibers of the electroresponsive submicron fiber layer. In some embodiments such loss is inhibited or mechanical damage prevented during manufacturing of the electroresponsive submicron fibers, during manufacturing or handling of efficiency-enhanced gas filter medium, or both. In some embodiments the support layer functions by collecting the electroresponsive submicron fibers of the electroresponsive submicron fiber layer during manufacturing of the electroresponsive submicron fibers. The third one of the two or more electrostatically-interacting fiber layers comprises a material that is not electrostatically charged or is electrostatically charged and has been constructed so that locally there is a difference between electrostatic charge of the downstream fiber layer and electrostatic charge of the electrostatically-charged fiber layer. The difference between the electrostatic charges is, for example, where electrostatic charge of the downstream fiber layer is a positive charge and electrostatic charge of the electrostatically-charged fiber layer is a negative charge, or vice versa such that electrical polarity of the charges are opposite. In some embodiments the downstream fiber layer comprises a material that is characterizable as having a relative static permittivity (εᵣ) at room temperature (20° C.) under 1 kilohertz (1000 Hertz) applied potential that is different than, and more preferably less than, the εᵣ for the electroresponsive material.

The downstream fiber layer can be comprised of any suitable material so long as the efficiency-enhanced gas filter medium retains at least some of the gas filtration efficiency enhancement. Organic polymer fiber materials, especially polypropylene, or glass fibers are particularly useful for preparing the downstream fiber layer and are employed in some embodiments of the invention efficiency-enhanced gas filter medium. In some embodiments the downstream fiber layer is as described later in any one of the Examples.

Method of Preparing the Efficiency-Enhanced Gas Filter Medium

Preferably, the invention method of the second embodiment comprises contacting a downstream face of an electrostatically-charged fiber layer to an upstream face of an electroresponsive submicron fiber layer in such a way that the electroresponsive submicron fiber layer and the electrostatically-charged fiber layer are in direct physical contact with each other, thereby preparing an efficiency-enhanced gas filter medium comprising a combination of two or more electrostatically-interacting fiber layers, wherein one of the two or more electrostatically-interacting fiber layers comprises the electrostatically-charged fiber layer and another one of the two or more electrostatically-interacting fiber layers comprises the electroresponsive submicron fiber layer. More preferably, the efficiency-enhanced gas filter medium so prepared is as described in any one of the preferred embodiments of the efficiency-enhanced gas filter medium comprising the combination of two or more electrostatically-interacting fiber layers.

In some embodiments the invention method of the second embodiment comprises contacting a downstream face of an electrostatically-charged fiber layer to an upstream face of an intermediate fiber layer (preferably non-insulating) and contacting a downstream face of the intermediate fiber layer to an upstream face of an electroresponsive submicron fiber layer in such a way that the intermediate fiber layer has a thickness between its upstream and downstream faces equal to or less than an effective electroresponsive distance such that the upstream face of the electroresponsive submicron fiber layer is disposed within the effective (preferably uninsulated) electroresponsive distance from the downstream face of the electrostatically-charged fiber layer, thereby preparing an efficiency-enhanced gas filter medium comprising three or more layers being sequentially the electrostatically-charged fiber layer, intermediate fiber layer, and the electroresponsive submicron fiber layer. Preferably, the thickness of the intermediate fiber layer is 2 millimeters or less such that distance between the downstream face of the electrostatically-charged fiber layer and upstream face of the electroresponsive submicron fiber layer is 2 millimeters or less.

In some embodiments the invention method of the second embodiment comprises depositing the electroresponsive submicron fibers onto an upstream face of a downstream fiber layer in such a way so as to produce the electroresponsive submicron fiber layer having a downstream face in direct physical contact to the upstream face of the downstream fiber layer, and contacting the upstream face of the electroresponsive submicron fiber layer to the downstream face of the electrostatically-charged fiber layer, thereby preparing an efficiency-enhanced gas filter medium comprising sequentially the electrostatically-charged fiber layer, electroresponsive submicron fiber layer, and downstream fiber layer. Alternatively, if desired, the electroresponsive submicron fiber layer can be stripped from the collector and deposited in contact to an intermediate layer or, preferably, to a downstream face of the electrostatically charged fiber layer. Still in another more preferred alternative, the electroresponsive submicron fibers are deposited directly (e.g., melt blown directly) onto the downstream face of the electrostatically-charged fiber layer.

Preferably the depositing comprises fabricating the electroresponsive submicron fibers and collecting the fabricated electroresponsive submicron fibers on a collector. Preferably, the fabricating comprises melt electrospinning, solvent electrospinning, melt blowing, or melt electroblowing the electroresponsive submicron fibers. More preferably, the fabricating comprises melt electrospinning, solvent electrospinning, or melt blowing, still more preferably melt blowing, even more preferably solvent electrospinning, and yet more preferably melt electrospinning the electroresponsive submicron fibers. More preferably, the collector comprises the downstream face of the electrostatically-charged fiber layer or, still more preferably, the upstream face of a downstream fiber layer. Still more preferably, the efficiency-enhanced gas filter medium so constructed further comprises a downstream fiber layer in operative contact to a downstream face of the electroresponsive submicron fiber layer.

The invention efficiency-enhanced gas filter medium can be prepared in any form suitable for gas filtration so long as the form does not eliminate the gas filtration efficiency enhancement. Examples of suitable forms are flat sheet, pleated, and cylindrical forms.

Layers of the invention efficiency-enhanced gas filter medium can be combined by any suitable composite filter medium construction method so long as the invention efficiency-enhanced gas filter medium retains its gas filtration efficiency enhancement characteristic. Examples of suitable methods are adhesive bonding, hot welding, calendaring, and physical entanglement of fibers from immediately adjacent layers.

In some embodiments the efficiency-enhanced gas filter medium is prepared as described later in any one of the Examples.

Article Comprising the Efficiency-Enhanced Gas Filter Medium

As mentioned previously, the invention contemplates manufactured articles comprising the invention efficiency-enhanced gas filter medium. Preferably, the manufactured article is a filter. Preferably the filter further comprises a frame or means of holding the invention efficiency-enhanced gas filter medium in such a way that a gas in need of filtration can be directed therethrough.

More preferably the filter is adapted for use in a vehicle (e.g., airplane, automobile, boat, trailer, train, and truck) for filtering a gas (e.g., air) entering or in a compartment of the vehicle (e.g., passenger cabin (e.g., for human or livestock), perishables compartment for plants, fruits, or vegetables, or clean room compartment for particulate sensitive materials such as silicon wafers).

In some embodiments the manufactured article is a filter adapted for use in a building for filtering a gas (e.g., air) entering or in a volumetric space of the building (e.g., a heating, ventilating air conditioning (HVAC) filter for homes, office buildings, or factories).

In some embodiments the manufactured article is as described later in any one of the Examples.

### Method of Filtering a Gas

As mentioned previously, the invention efficiency-enhanced gas filter medium is particularly valuable for filtering particulates from a gas containing particulates. Preferably the gas is in need of filtration. Preferably, the invention method of filtering a gas is characterizable by an enhanced gas filtration efficiency due to the gas filtration efficiency enhancement of the efficiency-enhanced gas filter medium. Thus, the invention efficiency-enhanced gas filter medium is especially useful in any current or future application enabled by the gas filtration efficiency enhancement thereof.

The invention contemplates filtering any gas (including vapors) in need thereof. Examples of suitable gases are air, molecular oxygen, molecular nitrogen, argon, helium, and a gaseous hydrocarbon (e.g., methane). Preferably, the gas being filtered is air. The gas in need of filtration means a gas containing particulates, preferably including particulates having sizes of 0.05 micron or larger. In some embodiments the particulates have sizes of 0.10 micron or larger, in other embodiments 0.20 micron or larger, and still other embodiments 0.50 micron or larger. In some embodiments the particulates have sizes of 1 millimeter (mm) or lower, in other embodiments 0.5 mm or lower, in other embodiments 0.30 mm or lower, and in still other embodiments 0.50 micron or lower. Examples of particulates suitable for being filtered by the invention efficiency-enhanced gas filter medium and method are biological debris (e.g., aerosolled skin particles), dirt, dusts (e.g., construction dust and house dust), pollens, powders, short fibers, and spores. In some embodiments the gas, particulates, or both are as described later in any one of the Examples.

### General Materials and Methods and Preparations Materials

### Electrostatically-Charged Fiber Layers:

INTREPID 684L (Kimberly-Clark Corporation, Dallas, Tex., USA): flat sheet having Frazier permeability of 100 cubic feet per square feet-minute (28 cubic meters per square meter-minute); basis weight of 3.25 ounces per square yard (900 grams per square meter or gsm); and a thickness of 53 mils (1.3 millimeter (mm)).

INTREPID 411H (Kimberly-Clark Corporation, Dallas, Tex., USA): flat sheet having Frazier permeability of 445 cubic feet per square feet-minute (125 cubic meters per square meter-minute); MERV 11 rating; basis weight of 3 ounces per square yard (102 grams per square meter or gsm); and a thickness of 140 mils (3.56 millimeter (mm))

Electroresponsive submicron fiber layers: see Examples P1a to P1c and P2a to P2c later.

Downstream fiber layers (functioning as protective and support layers):

ATEX polypropylene, 15 gsm and a thickness of 0.11 mm: ATEX Technologies, Inc., Pinebluff, N.C., USA

ATEX polypropylene, 25 gsm and a thickness of 0.15 mm: ATEX Technologies, Inc.

PGI spunbond polypropylene medium (Polymer Group Inc. (PGI), Charlotte, N.C., USA): 0.45 ounce per square yard (15 gsm), Frazier permeability 970 cubic feet per square feet-minute (272 cubic meters per square meter-minute); and a thickness of 8 mils (0.2 millimeter (mm)).

The polypropylene of the downstream fiber layers has a relative static permittivity at 23° C. and 1 kilohertz (kHz) applied potential of εᵣ 2.2.

### Methods

Basis weight of fiber layers is determined by ASTM-D3776 (Standard Test Methods for Mass Per Unit Area (Weight) of Fabric).

Electrostatic charge of electrostatically-charged fiber layers can be generated and is determined by ASTM-D4470 (Standard Test Method for Static Electrification).

Frazier permeability is determined by ASTM-D737 (Test Method for Air Permeability of Textile Fabrics).

Layer thickness of fiber layers is determined by ASTM-D5736 (Standard Test Method for Thickness of Highloft Nonwoven Fabrics) or ASTM-D5729 (Standard Test Method for Thickness of Nonwoven Fabrics), as the case may be.

Relative static permittivity (εᵣ) is determined according to ASTM-D150 (Standard Test Methods for AC Loss Characteristics and Permittivity (Dielectric Constant) of Solid Electrical Insulation)

Filter filtration efficiency and pressure drops with sodium chloride particles that are not charge-neutralized (NaCl procedure)

Filter filtration efficiencies and pressure drops with sodium chloride particles and air are determined according to DIN-71460-1 (except uses the sodium chloride particles) at a temperature of 23° C.±3° C. wherein the sodium chloride particles have an average diameter of from 0.020 micron to 0.50 micron and are not charge-neutralized; and wherein the air has 50%±5% relative humidity and flows at face velocity of 9.1 meters per minute (i.e., 30 feet per minute). Sizes of the sodium chloride particles are determined with a SCANNING MOBILITY PARTICLE SIZER™ spectrometer, TSI Incorporated, Shoreview, Minn., USA. Sodium chloride particles are prepared from by nebulizing a known concentration (e.g., 10 weight percent (wt %)) solution of pure NaCl in distilled water to give the NaCl particles.

Preferably air filtration efficiency and pressure drop testing procedures comply with DIN 71460-1 (Road vehicles—Air filters for motor passenger compartments—Part 1: Test for particulate filtration).

### Gas Filtration Efficiency Enhancement

This section provides additional details for the gas filtration efficiency enhancement determination described previously.

(a) For a given particle size, calculate postcombination (theoretically expected total) particle penetration of combined (composite) filter media (P_{combined}) as a multiplication product of precombination particle penetration of the electrostatically charged fiber layer (P_{electrostatic layer}) times precombination particle penetration of the electroresponsive submicron fiber layer (P_{submicron fiber layer}) as shown in equation 1 (eq. 1):

P_{combined}=P_{electrostatic layer}·P_{submicron fiber layer} eq.1

(b) For the given particle size, calculate postcombination (i.e., theoretically expected total) filtration efficiency of the combined composite filter media (ε_{combined}) with eq. 2:

E_{combined}=1−(1−P_{electrostatic layer})·(1−P_{submicron fiber layer}) eq.2

Procedure for determining number average molecular weight (Mₙ) of a MSA material by nuclear magnetic resonance spectroscopy

Proton nuclear magnetic resonance spectroscopy (proton NMR or ¹H-NMR) is used to determine monomer purity, copolymer composition, and copolymer number average molecular weight Mₙ utilizing the CH₂OH end groups. Proton NMR assignments are dependent on the specific structure being analyzed as well as the solvent, concentration, and temperatures utilized for measurement. For ester amide monomers and co-polyesteramides, d4-acetic acid is a convenient solvent and is the solvent used unless otherwise noted. For ester amide monomers of the type called DD that are methyl esters typical peak assignments are about 3.6 to 3.7 ppm for C(═O)—OCH₃; about 3.2 to 3.3 ppm for N—CH₂—; about 2.2 to 2.4 ppm for C(═O)—CH₂—; and about 1.2 to 1.7 ppm for C—CH₂—C. For co-polyesteramides that are based on DD with 1,4-butanediol, typical peak assignments are about 4.1 to 4.2 ppm for C(═O)—OCH₂—; about 3.2 to 3.4 ppm for N—CH₂—; about 2.2 to 2.5 ppm for C(═O)—CH₂—; about 1.2 to 1.8 ppm for C—CH₂—C, and about 3.6 to 3.75 —CH₂OH end groups.

### Fiber Size Sample Preparation and Fiber Size and Distribution Determination.

Fiber sizes are determined by scanning electron microscopy (SEM). Pieces of a fiber layer (e.g., submicron MSA fiber layer) are cut and glued to aluminum SEM stubs with carbon paint. The samples are coated with 5 nm of osmium using a Filgen Osmium Plasma Coater OPC-60A. They are imaged in an FEI Nova NanoSEM field emission gun scanning electron microscope (serial #D8134) at 5 keV, spot size 3, and a working distance of 5 mm. Depending on the size of the fibers, 5 to 20 images are collected at various magnifications for the purposes of measuring fiber diameters. At least one hundred measurements of fiber diameters are taken of each sample using various numbers of images depending on fiber density using ImageJ® image analysis software, then binned and graphed using Excel.

### Preparations

### Preparation 1a: Synthesis of a Molecular Self-Assembling Polyesteramide (Pea) Comprising 50 Mole Percent of ethylene-N,N′-dihydroxyhexanamide (C2C) Monomer (the MSA Material is Generally Designated as a PEA-C2C50%-1)

Step (a) Preparation of the Diamide Diol, ethylene-N,N′-dihydroxyhexanamide (C2C) Monomer

The C2C diamide diol monomer is prepared by reacting 1.2 kg ethylene diamine (EDA) with 4.56 kilograms (kg) of ε-caprolactone under a nitrogen blanket in a stainless steel reactor equipped with an agitator and a cooling water jacket. An exothermic condensation reaction between the ε-caprolactone and the EDA occurs which causes the temperature to rise gradually to 80 degrees Celsius (° C.). A white deposit forms and the reactor contents solidify, at which the stirring is stopped. The reactor contents are then cooled to 20° C. and are then allowed to rest for 15 hours. The reactor contents are then heated to 140° C. at which temperature the solidified reactor contents melt. The liquid product is then discharged from the reactor into a collecting tray. A nuclear magnetic resonance study of the resulting product shows that the molar concentration of C2C diamide diol in the product exceeds 80 percent. The melting temperature of the C2C diamide diol monomer product is 140° C.

Step (b): Contacting C2C with Dimethyl Adipate (DMA)

A 2.5 liter kneader/devolatizer reactor having feed cylinders 1 and 2 is charged at 50° C. to 60° C. with 0.871 kg of DMA (dimethyl adipate) and 0.721 kg of C2C diamide diol from step (a), with nitrogen blanket. The kneader temperature is slowly brought to 140° C. to 150° C. under nitrogen purge to obtain a clear solution. Then, still under nitrogen and at 140° C. to 150° C., 1,4-butanediol (1,4-BD) is loaded from a feed cylinder 1: 0.419 kg into the reactor and the mixture is homogenized by continued stiffing at 140° C. Subsequently, Ti(OBu)₄ catalyst is injected from feed cylinder 2 as 34.84 gram of a 10% by weight solution in 1,4-BD (4000 ppm calculated on DMA; 3.484 g catalyst plus 31.36 g 1,4-BD; total content of 1,4-BD is 0.450 kg). The kneader temperature is increased stepwise to 180° C. over a period of 2 hours to 3 hours at atmospheric pressure; initially with low (to prevent entrainment of the monomers DMA and BD) nitrogen sweep applied. Methanol fraction is distilled off and collected (theoretical amount: 0.320 kg) in a cooling trap.

Step (c): Distilling 1,4-butanediol and Polycondensation to Give PEA-C2C50%-1

When the major fraction of methanol is removed, the kneader pressure is stepwise decreased first to 50 mbar-20 mbar and further to 5 mbar to complete the methanol removal and to initiate the 1,4-BD distillation. The pressure is further decreased <1 mbar or as low as possible, until the slow but steady distillation of 1,4 butane diol is observed (calculated amount 0.225 kg). During this operation the temperature is raised to 190° C. to 200° C. at maximum as to avoid discoloration. Towards the end of the reaction samples are taken from the reactor to check the viscosity. The target point is 1.5 Pa·sec to 2 Pa·sec. at 180° C. for a molecular weight Mₙ (by ¹H-NMR) of 5,000 g/mol. When the 1,4-butanediol removal is completed, the kneader is cooled to about 150° C. (depending on torque measured) and brought to atmospheric pressure under nitrogen blanket and the_PEA-C2C50%-1 polymer is collected.

From the PEA-C2C50%-1 polymer 2 mm thick compression molded plaques are produced. Prior to compression molding, the polymer is dried at 60° C. under vacuum for about 24 hours. Plaques of 160 millimeters (mm)×160 mm×2 mm are obtained by compression molding isothermally at 160° C., 6 minutes at 10 bar and afterwards 3 minutes at 150 bar. The samples are cooled from 160° C. to room temperature at 20° C./minute. The zero shear viscosity data are obtained on the Advanced Rheometric Expansion System (ARES, TA Instruments, New Castle, Del., USA) with parallel plate setup and are reported in Table A. Dynamic Frequency Sweep tests are performed from 100 radians per second (rad./sec.) to 0.1 rad./sec. (30% strain) under nitrogen atmosphere. Also thermal behavior is checked by performing a time sweep for one hour at a frequency of 10 rad/sec and 30% strain. Crystallization behavior is determined with a temperature sweep from 180° C. to 80° C. (10 rad/sec adjusted strain during experiment). All tests are done under nitrogen gas atmosphere and on dried samples. Separately, determine relative static permittivity of one of the plaques at 23° C. and 1 kilohertz (kHz) applied potential. Properties are presented in Table A.

TABLE A
characterization of PEA-C2C50%-1

| | PEA-C2C50%-1 | |
|---|---|---|
| Mₙ (by ¹H-NMR) | 5,000 | g/mol |
| Crystallization temperature T_{c} (° C.) | 130° | C. |
| Glass transition temperature T_{g} (° C.) | 95° | C. |
| Melt zero shear viscosity | | |
| At 180° C. | 1.49 | Pa · s |
| At 160° C. | 2.6 | Pa · s |
| At 140° C. | 4.8 | Pa · s |

| | |
|---|---|
| Relative static permittivity | 12.6 |
| At 23° C. and 1 kHz | |

### Preparation 1b: Preparation of MSA copolyesteramide with 51 Mole % Amide (C2C) Residual Content (PEA-C2C51%-1)

In general the synthesis is characterized by the reaction of the diamide diol (Prep. 1a step (a); i.e., ethylene-N,N″-dihydroxyhexanamide) with dimethyl adipate (DMA) and 1,4-butanediol (1,4-BD or BD). In a preheated kneader reactor DTB 63 BM (LIST AG, CH-4422 Arisdorf, Switzerland) connected with a vacuum unit 28.90 kg diamide diol are dried for two hours under vacuum at 132° C. After that the diamide diol is mixed with 34.91 kg DMA and 16.80 kg (2-fold excess) 1,4-butanediol (1,4-BD), (40 rpm) under nitrogen. The temperature is then slowly brought to 145° C. until the mixture is clear. At this temperature a 10% by weight solution of titanium tetrabutoxide (Ti(BuO)₄) catalyst in 1,4-BD (4000 ppm calculated on DMA: 140 g catalyst and 1260 g 1,4-BD, total amount of 1,4-BD is 18.06 kg) is added. After addition of the catalyst is complete, methanol distillation is started immediately and continued at ambient pressure for 4.18 hours. During this time the kneader temperature is increased slowly to 180° C. After this period the receiver for the distillate is emptied and the reaction continued by gradually applying a vacuum. Within about 1 hour the vacuum is increased to about 10 mbar. Before further lowering the pressure, collected distillate is combined with the previous fraction. In total 14.30 kg methanol fractions are collected. The polycondensation process is continued for about 7 hours at 190° C. The total reaction time in vacuum is 11.32 hours. In total 7.97 kg 1,4-butanediol fractions are collected during this period. After viscosity of 1700 milliPascal·seconds (mPa·sec) to 2100 mPa·s (measured 180° C.) is reached, the kneader is discharged and granules are produced to give 57.33 kg of PEA-C2C51% having 50.73 mol % diamide diol-residual content. Analysis of the granules: zero shear viscosity at 180° C.: 1835 mPa·s (i.e., 1.6 pascal seconds), Mn (¹H-NMR): 4500 g/mol, C2C-residual content (H-NMR): 50.73 mol %. The material is pelletized to give PEA-C2C51%-1 as pellets having zero shear viscosity at 180° C.: 1655 mPa·s (1.66 Pa·s), Mn (¹H-NMR): 4800 g/mol.

Non-limiting examples of the present invention are described below that illustrate some specific embodiments and aforementioned advantages of the present invention. Preferred embodiments of the present invention incorporate one limitation, and more preferably any two, limitations of the Examples, which limitations thereby serve as a basis for amending claims.

### EXAMPLE(S) OF THE PRESENT INVENTION

### Examples P1a to P1e

### Melt Electrospinning PEA-C2C50%-1 into Submicron Fibers

Use a commercially available Nanospider™ electrospinning apparatus from Elmarco s.r.o., Liberec, Czech Republic and a melt electrospinning procedure similar to that described in US 2010/0064647 A1.

The electrospinning apparatus includes three primary components: a high voltage power supply, a spinneret, and a collector (effectively a grounded conductor). The spinneret is a spin electrode comprising 5 or 4 spinning electrodes (as the case may be) each having one or two conductive wires. Bottom portions of the spinning electrodes (discs comprising polytetrafluoroethylene) are in contact with a melt of a fiber-forming material (e.g., the molecularly self-assembling (MSA) material useful in the present invention).

In separate experiments conducted at ambient temperature (25° C., 22° C., or 21.4° C., as the case may be), ambient pressure, and ambient relative humidity (RH; 49% RH, 56% RH, or 40% RH, as the case may be), the 5 or 4 spinning electrodes, as the case may be, are rotated at 15 revolutions per minute (rpm) in contact with a melt of PEA-C2C50%-1 (Preparation 1a) without any additive, wherein temperature of the melt is 200° C., 193° C., or 193° C., as the case may be. An electrode gap (the gap between the spinning electrodes and collector) is 32.5 centimeters (cm), 40 cm, or 27 cm, as the case may be. A voltage (150 volts (V), 150 V, or 155 V, as the case may be, is applied to heat the wires, and the wires of the spinning electrodes become electrified to give an applied voltage difference of 110 kV, 120 kV, or 110 kV, as the case may be. The PEA-C2C50%-1 are drawn to a grounded collector comprising ATEX polypropylene fiber layer (15 gsm, 15 gsm, 25 gsm, 15 gsm, or 15 gsm as the case may be), which will serve as a downstream fiber layer in contact with the downstream face of the submicron MSA fiber layer being produced herein. The collector is placed opposite the spinning electrodes and is moving at a speed of 1.5 meters per minute (m/min), 1.0 m/min, or 1.0 m/min, as the case may be. While being drawn to the collector, the jets cool and harden into submicron MSA fibers. The submicron MSA fibers are deposited onto a side of the collector that will become an upstream face of the downstream fiber layer. The submicron MSA fibers are deposited as a randomly oriented, non-woven mat, thereby forming the submicron MSA fiber layer. Each of the combined submicron MSA fiber layer/ATEX polypropylene downstream fiber layer of Examples P1a to P1e is rolled up onto a roll for ease of storage and transport. Results are shown below in Table B.

TABLE B
melt electrospinning of electroresponsive submicron MSA fibers

| | collector | collector | | | | | Electrode | | | Applied |
|---|---|---|---|---|---|---|---|---|---|---|
| | Basis | line | | Ambient | Melt | | rotation | Electrode | Electrode | voltage |
| Prep. | wt. | speed, | RH | Temp. | temp. | No. | rate | gap | voltage | diff. |
| No. | (gsm) | m/min | (%) | (° C.) | (° C.) | electrodes | (rpm) | (cm) | (V) | (kV) |
| P1a | 15 | 1.5 | 49% | 25 | 200 | 5 | 15 | 32.5 | 150 | 110 |
| P1b | 15 | 1.0 | 56% | 22 | 193 | 5 | 15 | 40 | 150 | 120 |
| P1c | 25 | 1.0 | 40% | 21.4 | 193 | 4 | 15 | 27 | 155 | 110 |
| P1d | 15 | 1.5 | 49% | 25 | 200 | 5 | 15 | 32.5 | 150 | 110 |
| P1e | 15 | 1.5 | 49% | 25 | 200 | 5 | 15 | 32.5 | 150 | 110 |

Wherein wt. means weight;
gsm means grams per square meter surface area of fiber layer;
RH (%) means relative humidity (percent);
Temp. means temperature;
No. means number;
rpm means revolutions per minute;
cm means centimeters;
V means volts;
kV means kilovolts; and
diff. means difference.

These melt electrospinning experiments produce submicron MSA fibers having a median fiber diameter and basis weight of 290 nanometers (nm) and 2.45 gsm; 290 nm and 3.17 gsm; 255 nm and 0.74 gsm; 290 nanometers (nm) and 2.45 gsm; and 290 nanometers (nm) and 2.45 gsm in Examples P1a to P1e, respectively. The Frazier permeability was measured at about 79 feet per minute (24 m/min), 44 feet per minute (13 m/min), and 88 feet per minute (7 m/min) in Examples P1a to P1c, respectively. The submicron MSA fibers and submicron fiber layer prepared by the process described above are electroresponsive.

In general, the aforementioned process produces submicron MSA fibers having a median diameter of 500 nm or less, more preferably about 400 nm or less, and more preferably about 300 nm or less. Particularly preferred are submicron MSA fibers with median diameters of about 200 nm to 300 nm.

### Examples P2a to P2c

### Melt Blowing PEA-C2C51%-1 into Submicron Fibers

Use a melt blowing machine as described in U.S. Pat. No. 6,833,104 B2 from Hill's Incorporated of West Melbourne, Fla. 32904. See also the article “Potential of Polymeric Nanofibers for Nonwovens and Medical Applications” by Dr John Hagewood, J. Hagewood, LLC, and Ben Shuler, Hills, Inc, published in the 26 Feb. 2008 Volume of Fiberjournal.com. This melt blowing machine includes extrusion and material transfer manifolds that connect to the melt-blown die system. A melt pump feeds a melt of a material to be melt blown from a source thereof through the extrusion manifold to a die defining a plurality of die spinholes. The die spinhole (e.g. “hole”) density is 100 holes per inch (but can apparently be larger or smaller), and each hole has a diameter of 0.1 mm and a length to diameter ratio (L/D) of greater than 100/1.

Use a melt blowing procedure similar to that described in US 2010/0037576 A1. Prepare melt-blown fibers having submicron diameters using a proprietary melt-blowing system manufactured, and operated by Hill's Incorporated of West Melbourne, Fla. 32904, described above.).

In separate experiments a melt of the PEA-C2C51%-1 (Preparation 1b) is run and fibers are melt-blown into non-woven webs. The PEA-C2C51%-1 is melt-blown into a web of submicron MSA fibers from a melt of the PEA-C2C51%-1 at melt temperature of from about 158° C. to about 174° C. and using a stretch air temperature between about 210° C. and 225° C. Average air speed as it first reaches the flow of melted PEA-C2C51%-1 is modeled as a function of the square root of the air pressure with 1 pound per square inch (7 kilopascals) of air pressure producing an average air speed of about 120 meter per second. The melt blown submicron MSA fibers are deposited on a typical porous, spun bonded, PGI polypropylene collector, having a basis weight about 25 grams per square meter. The collector moves relative to the blown web deposition at a line speed of from about 4.8 meters per minute (m/min) to 34 m/min. The melt-blowing rate is from about 0.0077 grams/minute/spinhole or 1.8 kilograms/hour/meter to about 0.011 grams/minute/spinhole or 2.6 kilogram/hour/meter. The submicron MSA fibers are deposited onto a side of the PGI polypropylene collector that will become an upstream face of the downstream fiber layer. The submicron MSA fibers are deposited as a randomly oriented, non-woven mat, thereby forming the submicron MSA fiber layer to give three combined submicron MSA fiber layer/PGI polypropylene downstream fiber layer composites of Examples P2a to P2c. The submicron MSA fiber layer/PGI polypropylene downstream fiber layer composites are separately rolled up onto a roll for ease of storage and transport. Melt blowing conditions are described below in Table C.

TABLE C
melt blowing conditions.

| | Rate of | | | | | | |
|---|---|---|---|---|---|---|---|
| | MSA fiber | | | | | | Melt |
| | production | Collector | Aspirator | Distance | Stretch | | Pump |
| | (g per hole | run | Press | to | Air | Pack | Outlet |
| Example | per | speed | (psi, | Collector | Heat | Temp | Press (psi, |
| Number | minute) | (m/min) | (kPa)) | (in (cm)) | (° C.) | (° C.) | (kPa)) |
| P2a | 0.009 | 3.5 | 4 (30) | 6.75 (17.1) | 211 | 190 | 160 (1100) |
| P2b | 0.0029 | 2.6 | 1 (7) | 6.75 (17.1) | 204 | 175 | 256 (1760) |
| P2c | 0.0033 | 7.6 | 1 (7) | 6.75 (17.1) | 188 | 174 | 220 |

These melt blowing experiments produce submicron MSA fibers having a median fiber diameter and basis weight of 320 nm and 3.15 gsm; 300 nm and 4.57 gsm; and 240 nm and 2.8 gsm of Examples P2a to P2c, respectively. The submicron MSA fibers and submicron fiber layer prepared by the process described above are electroresponsive.

### Examples 1a to 1c

### Preparing 3-Layer Efficiency-Enhanced Gas Filter Media with Melt Electrospun PEA-C2C50%-1 Submicron Fiber Layer

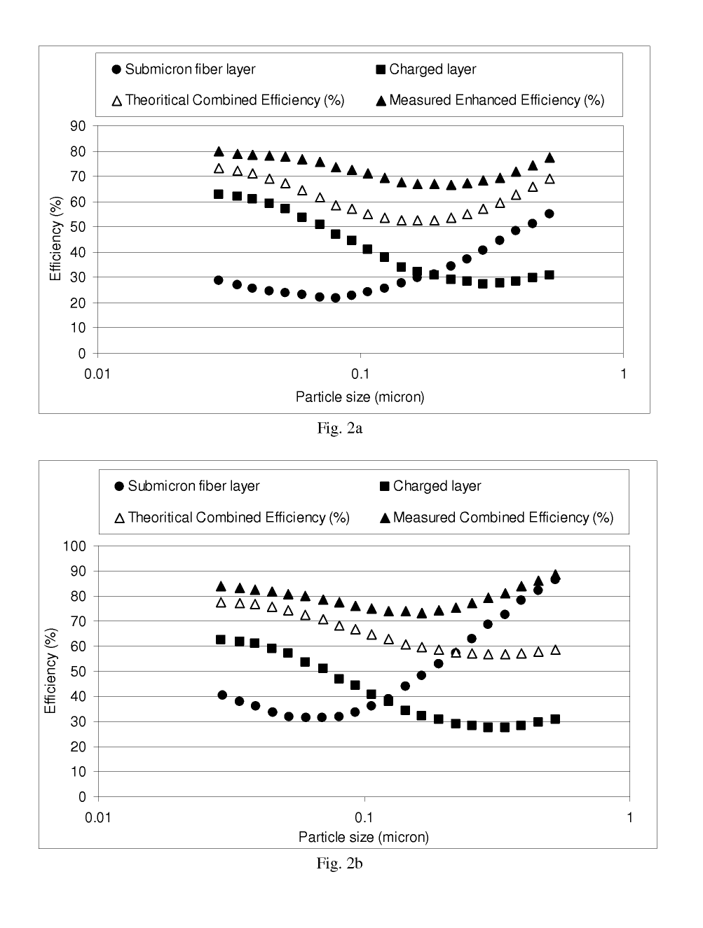

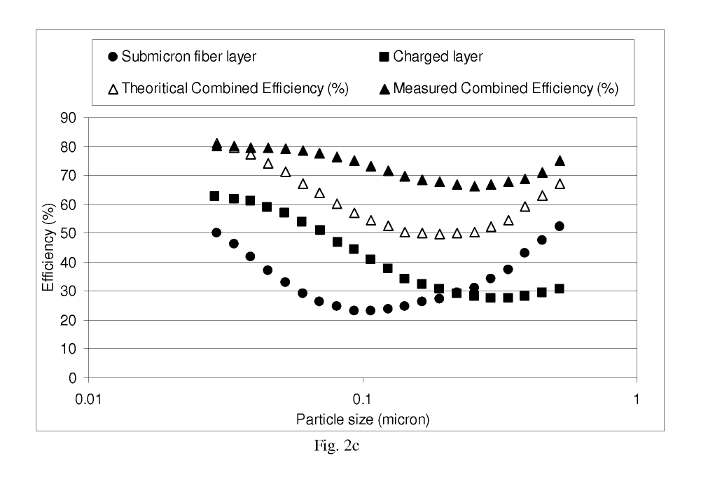

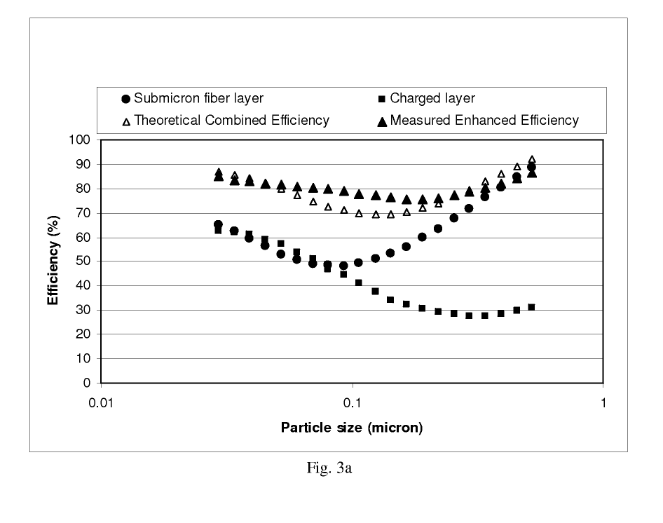

Preparing three constructions, contact a downstream face of INTREPID 684L flat sheet to an upstream face of MSA submicron fiber layer portion of the MSA submicron fiber layer/ATEX polypropylene downstream fiber layer composite of Examples P1a to P1c, respectively, to give the 3-layer efficiency-enhanced gas filter media of Examples 1a to 1c. Separately measure NaCl particle penetrations of the INTREPID 684L precursor layer and submicron MSA fiber layer/ATEX polypropylene downstream fiber layer composites of Examples P1a to P1c. Measure the postcombination particle penetration of the efficiency-enhanced gas filter media of Examples 1a to 1c at least one time and calculate the (theoretically expected total) postcombination particle penetration from the NaCl measurements with the separate layers, and find that the filter media of Examples 1a to 1c independently exhibit the gas filtration efficiency enhancement. FIGS. 2a to 2c show the gas filtration efficiency enhancements of the efficiency-enhanced gas filter media of Examples 1a to 1c, respectively, over a range of 0.02 micron to 0.50 micron particle sizes. An average of the gas filtration efficiency enhancement results from Examples 1a to 1c is shown later in Table 1.

### Example 1d

### Preparing 3-Layer Efficiency-Enhanced Gas Filter Media with Melt Electrospun PEA-C2C50%-1 Submicron Fiber Layer

Repeat the procedure of Example 1a except use INTREPID 411H flat sheet as the electrostatically-charged fiber layer instead of the INTREPID 684L flat sheet. Find that the filter media of Examples 1d exhibits the gas filtration efficiency enhancement. The gas filtration efficiency enhancement result is summarized later in Table 1.

### Example 1e

### Preparing 5-Layer Efficiency-Enhanced Gas Filter Media with Melt Electrospun PEA-C2C50%-1 Submicron Fiber Layer

Repeat the procedure of Example 1a except fold in half the MSA submicron fiber layer/ATEX polypropylene downstream fiber layer composite of Example P1a such that a four-layer combination of, from upstream to downstream, a first ATEX polypropylene fiber layer, first MSA submicron fiber layer, second MSA submicron fiber layer, and second ATEX polypropylene fiber layer, and contact a downstream face of INTREPID 684L flat sheet to an upstream face of the first ATEX polypropylene fiber layer to give the 5-layer efficiency-enhanced gas filter media of Example 1e. Find that the filter media of Example 1e exhibits the gas filtration efficiency enhancement. The gas filtration efficiency enhancement result is summarized later in Table 1.

### Examples 2a to 2d

### Preparing 3-Layer Efficiency-Enhanced Gas Filter Media with Melt Blown PEA-C2C51%-1 Submicron Fiber Layer

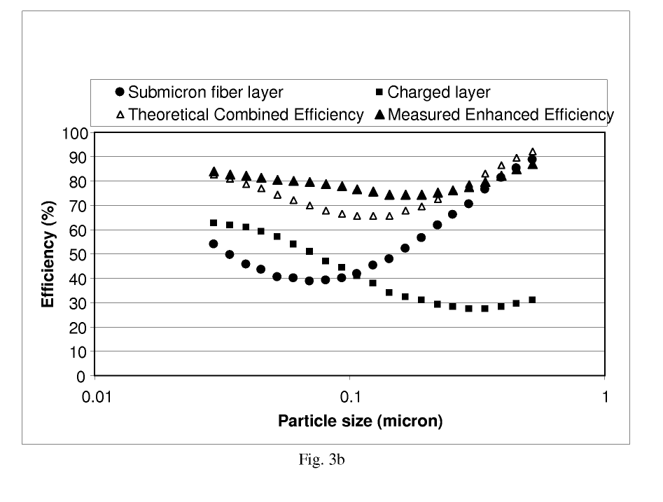

Preparing four constructions, contact a downstream face of INTREPID 684L flat sheet to an upstream face of a MSA submicron fiber layer portion of one of the MSA submicron fiber layer/PGI polypropylene downstream fiber layer composites of Examples P2a to P2c and P2a to respectively give the 3-layer efficiency-enhanced gas filter media of Examples 2a to 2c and 2d. Separately measure NaCl particle penetrations of the INTREPID 684L precursor layer and submicron MSA fiber layer/PGI polypropylene downstream fiber layer composites of Examples P2a to P2c and P2d. Measure the postcombination particle penetration of the efficiency-enhanced gas filter media of Examples 2a to 2c and 2d and calculate the (theoretically expected total) postcombination particle penetration from the NaCl measurements with the separate layers, and find that the filter media of Examples 2a to 2c and 2d independently the exhibit the gas filtration efficiency enhancement. Data for Examples 2c and 2d are not provided. FIGS. 3a and 3b show the gas filtration efficiency enhancements of the efficiency-enhanced gas filter media of Examples 2a and 2b, respectively over a range of 0.02 micron to 0.50 micron particle sizes. An average of the gas filtration efficiency enhancement results from Examples 2a and 2b are shown later in Table 1.

### Examples 3a and 3b and 3c and 3d

### Preparing and Testing of a 3-Layer Efficiency-Enhanced Gas Filter Medium Prepared with a Combination of Solvent Electrospun Nylon-6 Electroresponsive Submicron Fiber Layer

Preparing four constructions, contact a downstream face of INTREPID 684L flat sheet to an upstream face of a nylon-6 submicron fiber layer/PGI polypropylene layer composite to respectively give the 3-layer efficiency-enhanced gas filter media of Examples 3a and 3b and 3c and 3d. The nylon-6 submicron fiber layer of Examples 3a and 3b, and of Examples 3c and 3d, respectively comprises solvent electrospun nylon-6 fibers having a median fiber diameter and basis weight of 220 nm and 0.04 gsm; or 210 nm and 0.09 gsm as the electroresponsive submicron fiber layer and PGI polypropylene as downstream fiber layer. The solvent electrospun nylon-6 fibers are prepared according to the high-output solvent-based electrospinning method of WO 2008/150970 and its U.S. family member U.S. Ser. No. 12/601,397 using the Nanospider™ electrospinning apparatus from Elmarco s.r.o. Separately measure NaCl particle penetrations of the INTREPID 684L precursor layer and nylon-6 submicron fiber layer. Measure the postcombination particle penetration of the efficiency-enhanced gas filter media of Examples 3a and 3b. Calculate the (theoretically expected total) postcombination particle penetration from the NaCl measurement with the separate layers, and find that the filter media of Examples 3a and 3b exhibit the gas filtration efficiency enhancement over a range of 0.02 micron to 0.50 micron particle sizes. An average of the gas filtration efficiency enhancement results from the measurements of Examples 3a and 3b are shown below in Table 1.

TABLE 1
summary of gas filtration efficiency enhancement results
over a range of 0.02 micron to 0.50 micron particle sizes

| | reduction factor (r) | smallest reduction factor (r) |
|---|---|---|
| Example | at combined MPP | for particle sizes between |
| Number | size | 0.05 micron and 0.2 micron |
| 1a | 0.72 | 0.63 |
| 1b | 0.76 | 0.63 |
| 1c | 0.82 | 0.69 |
| 1d | 0.85 | 0.74 |
| 1e | 0.73 | 0.60 |
| 2a | 0.88 | 0.73 |
| 2b | 0.79 | 0.66 |
| 3a | 0.80 | 0.80 |

MPP means most penetrating particle of combination layer.

Using charged-neutralized INTREPID 684L flat sheet (prepared by contacting INTREPID 684L flat sheet with a charge-neutralizing amount of 2-propanol) instead of INTREPID 684L flat sheet provides a non-invention filter medium that does not provide a gas filtration efficiency enhancement.

As shown by the Examples, the invention efficiency-enhanced gas filter medium is useful in any current or future applications where gas filter media can be employed. Examples of such current applications are air filter media for vehicle compartments and buildings. The invention efficiency-enhanced gas filter medium is also useful in any current or future application enabled by the gas filtration efficiency enhancement thereof.

While the present invention has been described above according to its preferred aspects or embodiments, it can be modified within the spirit and scope of this disclosure. This application is therefore intended to cover any variations, uses, or adaptations of the present invention using the general principles disclosed herein. Further, the application is intended to cover such departures from the present disclosure as come within the known or customary practice in the art to which this present invention pertains and which fall within the limits of the following claims.

1. An efficiency-enhanced gas filter medium comprising at least two fiber layers comprising a combination of two or more electrostatically-interacting fiber layers such that the efficiency-enhanced gas filter medium is characterizable by a gas filtration efficiency enhancement from the combination of the two or more electrostatically-interacting fiber layers, wherein the gas filtration efficiency enhancement is characterized as follows:
Taken alone each of the two or more electrostatically-interacting fiber layers, independently would be characterizable by a precombination particle penetration;
The combination of the two or more electrostatically-interacting fiber layers is characterizable by a measured postcombination particle penetration and a calculated postcombination particle penetration, wherein the calculated postcombination particle penetration is equal to a multiplication product of the precombination particle penetrations; and
The gas filtration efficiency enhancement of the efficiency-enhanced gas filter medium is characterizable by a reduction in postcombination particle penetration such that the measured postcombination particle penetration of the combination is less than 0.95 times the calculated postcombination particle penetration; and
Wherein all particle penetrations are measured based on a same size test particle having a size from 0.05 micron to 0.20 micron under same measurement conditions.

2. The efficiency-enhanced gas filter medium as in claim 1, wherein the same size test particle is a most penetrating particle size and the gas filtration efficiency enhancement of the efficiency-enhanced gas filter medium is characterizable by the reduction in postcombination particle penetration such that the measured postcombination particle penetration of the combination is less than 0.90 times the calculated postcombination particle penetration.

3. The efficiency-enhanced gas filter medium as in claim 2, wherein the gas filtration efficiency enhancement of the efficiency-enhanced gas filter medium is characterizable by the reduction in postcombination particle penetration such that the measured postcombination particle penetration of the combination is less than 0.85 times the calculated postcombination particle penetration.

4. The efficiency-enhanced gas filter medium as in claim 1, wherein one or more of the two or more electrostatically-interacting fiber layers comprises submicron fibers comprising an electroresponsive material comprising an electroresponsive organic polymer.

5. The efficiency-enhanced gas filter medium as in claim 1, wherein:
One of the two or more electrostatically-interacting fiber layers comprises an electrostatically-charged fiber layer comprising electrostatically-charged fibers and having spaced-apart upstream and downstream faces and an effective amount of an electrostatic charge, wherein the electrostatically-charged fibers have a median fiber diameter of from greater than 500 nanometers to 1000 microns; and
Another one of the two or more electrostatically-interacting fiber layers comprises an electroresponsive submicron fiber layer having spaced-apart upstream and downstream faces and comprising electroresponsive submicron fibers comprising an electroresponsive material, wherein the electroresponsive submicron fibers have a median fiber diameter of 500 nanometers or less and the electroresponsive material is characterizable as having a relative static permittivity (εᵣ) of 2.6 or greater at room temperature under 1 kilohertz applied potential; and
Wherein the electroresponsive submicron fiber layer is disposed within an electroresponsive distance from the electrostatically-charged fiber layer in such a way so as to produce the gas filtration efficiency enhancement.

6. The efficiency-enhanced gas filter medium as in claim 5, wherein the electroresponsive distance is 2.0 millimeters or less.

7. The efficiency-enhanced gas filter medium as in claim 5, wherein the downstream face of the electrostatically-charged fiber layer and the upstream face of the electroresponsive submicron fiber layer are disposed in direct physical contact with each other

8. The efficiency-enhanced gas filter medium as in claim 1, wherein the electroresponsive material comprises an electroresponsive organic polymer.

9. The efficiency-enhanced gas filter medium as in claim 8, wherein the electroresponsive organic polymer is an electroresponsive polyamide or an electroresponsive molecularly self-assembling material.

10. The efficiency-enhanced gas filter medium as in claim 9, wherein the electroresponsive organic polymer is the electroresponsive molecularly self-assembling material and the electroresponsive molecularly self-assembling material comprises repeat units of formula I: 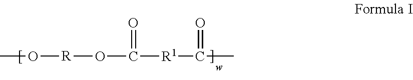
and at least one second repeat unit selected from the ester-amide units of Formula II and III: 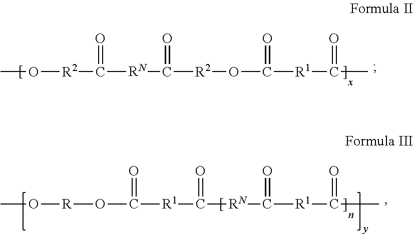
and the ester-urethane units of Formula IV: 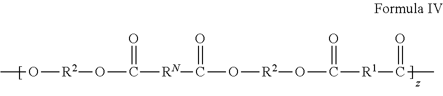
or combinations thereof
wherein:
R is at each occurrence, independently a C₂-C₂₀ non-aromatic hydrocarbylene group, a C₂-C₂₀ non-aromatic heterohydrocarbylene group, or a polyalkylene oxide group having a group molecular weight of from about 100 grams per mole to about 5000 grams per mole;
R¹ at each occurrence independently is a bond or a C₁-C₂₀ non-aromatic hydrocarbylene group;
R² at each occurrence independently is a C₁-C₂₀ non-aromatic hydrocarbylene group;
R^{N} is —N(R³)—Ra—N(R³)—, where R³ at each occurrence independently is H or a C₁-C₆ alkylene and Ra is a C₂-C₂₀ non-aromatic hydrocarbylene group, or R^{N} is a C₂-C₂₀ heterocycloalkyl group containing the two nitrogen atoms, wherein each nitrogen atom is bonded to a carbonyl group according to formula (III) above;
n is at least 1 and has a mean value less than 2; and
w represents the ester mol fraction of Formula I, and x, y and z represent the amide or urethane mole fractions of Formulas II, III, and IV, respectively, where w+x+y+z=1, and 0<w<1, and at least one of x, y and z is greater than zero but less than 1.

11. The efficiency-enhanced gas filter medium as in claim 10, wherein the number average molecular weight (Mn) of the electroresponsive molecularly self-assembling material is from 2000 grams per mole to 12,000 grams per mole.

12. The efficiency-enhanced gas filter medium as in claim 5, wherein the electroresponsive submicron fibers have a median fiber diameter of 320 nanometers or less.

13. The efficiency-enhanced gas filter medium as in claim 5, wherein the efficiency-enhanced gas filter medium further comprises a downstream fiber layer in laminating operative contact to the downstream face of the electroresponsive submicron fiber layer.

14. The efficiency-enhanced gas filter medium as in claim 13, wherein the downstream fiber layer comprises fibers comprising a polypropylene.

15. A method of constructing the efficiency-enhanced gas filter medium of claim 1, the method comprising combining the two or more electrostatically-interacting fiber layers together in such a way so as to produce a efficiency-enhanced gas filter medium comprising at least two fiber layers comprising a combination of two or more electrostatically-interacting fiber layers such that the efficiency-enhanced gas filter medium is characterizable by a gas filtration efficiency enhancement from the combination of the two or more electrostatically-interacting fiber layers.

16. The method as in claim 15, the method combining comprising contacting a downstream face of an electrostatically-charged fiber layer to an upstream face of an electroresponsive submicron fiber layer in such a way that the electroresponsive submicron fiber layer and the electrostatically-charged fiber layer are in direct physical contact with each other, thereby preparing an efficiency-enhanced gas filter medium comprising a combination of two or more electrostatically-interacting fiber layers, wherein one of the two or more electrostatically-interacting fiber layers comprises the electrostatically-charged fiber layer and another one of the two or more electrostatically-interacting fiber layers comprises the electroresponsive submicron fiber layer.

17. A method of filtering a gas, the method comprising directing a gas having particulates and in need of filtration through the efficiency-enhanced gas filter medium as in claim 1 in such a way that the gas is filtered, thereby providing a filtered gas having a reduced amount of particulates.

18. A manufactured article comprising the efficiency-enhanced gas filter medium as in claim 1.

19. The manufactured article as in claim 18, wherein the manufactured article is a filter adapted for use in a vehicle for filtering a gas entering or in a compartment of the vehicle.

20. The manufactured article as in claim 18, wherein the manufactured article is a filter adapted for use in a building for filtering a gas entering or in a volumetric space of the building.
